(19) United States
(12) Patent Application Publication
(10) Pub. No.: US 2026/0164524 A1
(43) Pub. Date: Jun. 11, 2026

(54) LED DRIVING SYSTEMS

(71) Applicant: O2Micro, Inc., Santa Clara, CA (US)

(72) Inventors: Hiroshi YAMAZAKI, Tokyo (JP); Hideaki OTSUKA, Tokyo (JP); Rong HU, Beijing (CN)

(21) Appl. No.: 19/326,254

(22) Filed: Sep. 11, 2025

Related U.S. Application Data
(60) Provisional application No. 63/730,419, filed on Dec. 10, 2024.

(30) Foreign Application Priority Data
Aug. 18, 2025 (CN) 202511152259.2

(51) Int. Cl. H05B 47/155; H05B 45/37; H05B 47/165

(52) U.S. Cl. CPC H05B 47/155; H05B 45/37; H05B 47/165

(57) ABSTRACT

A system includes a chain of LED drivers, a controller, and bridge circuitry. Each LED driver drives a set of LEDs and communicates with the other LED drivers in the chain of LED drivers through a first protocol. The controller controls the LED drivers to drive multiple sets of LEDs and supports a second protocol. The bridge circuitry receives status information, indicative of a status of the multiple sets of LEDs, from the chain of LED drivers, and generates a feedback signal to control power provided to the LEDs based on the status information. The bridge circuitry includes a first interface coupled to the chain of LED drivers and configured to support the first protocol, and includes a second interface coupled to the controller and configured to support the second protocol. The bridge circuitry enables communication between the LED drivers and the controller through the first and second interfaces.

### RELATED APPLICATIONS

This application claims priority to the U.S. Provisional Application with Serial No. 63/730,419, filed on December 10, 2024, and claims benefit under 35 U.S.C. § 119(a) to Application No. 202511152259.2, filed with the State Intellectual Property Office of the People’s Republic of China on August 18, 2025, which are hereby incorporated by reference in their entirety.

### BACKGROUND

FIG. 1A illustrates a block diagram of a conventional light emitting diode (LED) driving system 100A for driving mini-LEDs 116 in a backlight panel 112A. The LED driving system 100A includes a DC/DC (direct current to direct current) converter 102, an MCU (microcontroller unit) 106A, and a backlight panel 112A. The MCU 106A controls the DC/DC converter 102 to power the backlight panel 112A. The backlight panel 112A includes multiple sets of mini-LEDs 116 and multiple chains of LED drivers 114A that drive the mini-LEDs 116. In FIG. 1A, each LED driver is labeled “AMIC,” which stands for active-matrix integrated circuit. The MCU 106A is a typical MCU that supports the SPI (serial peripheral interface) protocol. The LED drivers 114A also support the SPI protocol so that the LED drivers 114A can communicate with the MCU 106A. The MCU 106A sends commands and parameters to the LED drivers 114A through SPI interfaces. The LED drivers 114A send feedback data to the MCU 106A through the SPI interfaces such that the MCU 106A controls the output power VLED of the DC/DC converter 102 based on the feedback data.

However, due to the use of SPI interfaces, the LED drivers 114A occupy a relatively large amount of PCB (printed circuit board) area. More specifically, a standard SPI interface includes at least three pins – a clock pin SCLK, a data-input pin SDI, and a data-output pin SDO. FIG. 2 shows a block diagram of a chain of LED drivers 114A supporting the SPI protocol. As shown in FIG. 2, the LED drivers 114A are connected in a daisy-chain arrangement and communicate with each other using the SPI protocol. Thus, the SPI interface of each LED driver includes four pins – a clock-input pin SCLKI, a clock-output pin SCLKO, a data-input pin SDI, and a data-output pin SDO. The LEDs 116 in the backlight panel 112A require a large number of LED drivers for operation, and each LED driver includes at least four pins for communication. The large number of pins and the associated wiring increase the PCB size and system cost, and complicate the PCB layout.

In addition, as shown in FIG. 1A, the MCU 106A includes a feedback module 108 (e.g., a digital to analog converter (DAC)) that converts the feedback data received from the LED drivers 114A to an analog feedback signal 104 to control the output power VLED of the DC/DC converter 102. The feedback module 108 (e.g., a DAC) can increase the cost of the MCU 106A.

Moreover, in some situations, the MCU 106A and the LED drivers 114A are placed a long distance apart, e.g., placed in different PCBs. In these situations, driver buffers 110 that support the SPI protocol are placed/inserted between the MCU 106A and the LED drivers 114A. The buffers 110 may further increase the PCB size and system cost. Because the buffers 110 provide only basic buffering functionality, including the buffers 110 in the LED driving system 100A may not be cost-effective.

FIG. 1B illustrates a block diagram of another conventional LED driving system 100B. In the LED driving system 100B, LED drivers in each chain of LED drivers 114B communicate with each other using the 1-Wire protocol. The 1-Wire interface of each LED driver includes two pins – a signal-input pin SDI and a signal output-pin SDO – which is two pins fewer the SPI interface. Thus, the LED drivers 114B may occupy a smaller PCB area and cost less compared to the abovementioned LED drivers 114A. An encode/decode software module 118 is installed in the MCU 106B. The encode/decode software module 118 is configured to convert between SPI data and 1-Wire data so that the MCU 106B can communicate with the LED drivers 114B. However, the encode/decode software module 118 can increase the cost of the MCU 106B. The data converting process also occupies extra time and resources of the MCU 106B, which can increase the power consumption of the MCU 106B and reduce the operational efficiency of the MCU 106B.

In addition, in the LED driving system 100B, the backlight panel 112B sends a feedback signal 120 to control the output power VLED of the DC/DC converter 102. Thus, the abovementioned feedback module 108 (e.g., a DAC) in the MCU 106A in FIG. 1A can be omitted in the MCU 106B. However, in FIG. 1B, the feedback signal 120 is generated by using each of the LED drivers 114B to generate an adjusting signal (e.g., an analog signal), and by using a feedback circuit 122 to collect and combine multiple adjusting signals (e.g., analog signals) from the multiple chains of LED drivers 114B.

More specifically, FIG. 3 illustrates a block diagram of a portion of the LED driving system 100B. As shown in FIG. 3, each LED driver monitors a status of a set of LEDs. For example, the LED driver 114-1 monitors a status of the LEDs 116-1, and the LED driver 114-2 monitors a status of the LEDs 116-2. Each LED driver includes an input pin ADJFIN and an output pin ADJFO. In the chain of LED drivers 114B, a first LED driver can output, at its ADJFO pin, a first adjusting signal (e.g., an analog signal) indicative of a first status of a first set of LEDs driven by the first LED driver. A second LED driver, adjacently coupled to the first LED driver, can receive the first adjusting signal at its ADJFIN pin, generate a second adjusting signal indicative of the first status and a second status of a second set of LEDs driven by the second LED driver, and output the second adjusting signal at its ADJFO pin. Similarly, a third LED driver, adjacently coupled to the second LED driver, can output, at its ADJFO pin, a third adjusting signal indicative of the first status, the second status, and a third status of a third set of LEDs driven by the third LED driver (herein, “adjacently coupled” in this context is used to mean that there is not an intervening LED driver between adjacently coupled LED drivers, although there may or may not be other hardware of some sort between any two adjacently coupled LED drivers). As a result, an LED driver (e.g., 114-1) that is at an end of the chain of the LED drivers 114B can output, from its ADJFO pin to the feedback circuit 122, an adjusting signal indicative statuses of the multiple sets of LEDs driven by the chain of the LED drivers 114B.

Similarly, in FIG. 1B, each chain of the multiple chains of LED drivers 114B can provide a respective adjusting signal to the feedback circuit 122. As a result, the feedback circuit 122 can control the output power VLED of the DC/DC converter 102 based on the statuses of the LEDs in the backlight panel 112B. However, the large number of the pins ADJFIN and ADJFO, and the associated wiring, increase the PCB size and system cost, and complicate the PCB layout.

FIG. 4 illustrates a block diagram of another conventional LED driving system 400. The LED driving system 400 includes a DC/DC converter 402, a chain of LED drivers 414-1 to 414-N (where N is a natural number), and an MCU 406. The DC/DC converter 402 provides an output voltage VLED to power multiple sets of LED strings 416-1 to 416-N. Each LED driver 414-1, 414-2, … or 414-N drives, and senses statuses of, a respective set of LED strings S1 to SM (where M is a natural number). The MCU 406 controls the output voltage VLED of the DC/DC converter 402 based on the statuses of the LED strings 416-1 to 416-N.

More specifically, each of the LED drivers 414-1 to 414-N includes sense terminals ISEN1 to ISENM coupled to its respective LED strings S1 to SM. The LED drivers 414-1 to 414-N can sense voltages at the terminals ISEN1 to ISENM to determine whether to increase or decrease the output voltage VLED. For example, if one or more of the voltages at the terminals ISEN1 to ISENM are less than a reference voltage VREF, then the LED drivers 414-1 to 414-N can inform the MCU 406 to increase the output voltage VLED. As a result, the output voltage VLED can be set to a voltage level such that voltages at the terminals ISEN1 to ISENM of all LED drivers 414-1 to 414-N are equal to or greater than the reference voltage VREF. However, in some practical situations, the LED strings S1 to SM may have different forward voltages, e.g., because they include different types of LEDs. If the differences between the forward voltages of the LED strings S1 to SM are relatively large, they may result in wasted power in the LED drivers 414-1 to 414-N and lead to thermal issues.

For example, FIG. 5 illustrates a circuit diagram of a portion of the LED driving system 400. As shown in FIG. 5, the LED driver 414-1 drives each of the LED strings S1 to SM by sinking a respective LED current. To set the LED currents through the LED strings S1 to SM to a predetermined level, voltages V_{ISEN1} to V_{ISENM} at the sense terminals ISEN1 to ISENM are required to be equal to or greater than a voltage threshold. Taking FIG. 5 for example, to set the LED currents through the LED strings S1 to SM to be 100mA, the voltages V_{ISEN1} to V_{ISENM} are required to be equal to or greater than 0.25V. The LED driver 414-1 can set a reference voltage VREF to a voltage level slightly greater than the threshold voltage 0.25V (e.g., 0.3V) and control (e.g., increase or decrease) the output voltage VLED of the DC/DC converter 402 to be 30V so that the voltages V_{ISEN1} to V_{ISENM} are equal to or greater than the reference voltage 0.3V.

As shown in FIG. 5, an LED current of 100mA causes the LED string S1 to have a forward voltage 29.7V and the LED string S2 to have a forward voltage 28V, for example. As a result, the voltage V_{ISEN2} at the sense terminal ISEN2 is 2V, which is significantly higher than the reference voltage of 0.3V. The voltage V_{ISEN2} of 2V is applied across the internal transistor Q2 and the sense resistor Rs, resulting in relatively high power consumption (including wasted power) and potentially causing the internal transistor Q2 to generate a substantial amount of heat. A backlight panel (e.g., 112A or 112B) can include a large number of sets of LED strings driven by a corresponding number of LED drivers. Accordingly, differences among the forward voltages of the LED strings in the backlight panel can result in significant power loss in the LED drivers 414-1 to 414-N and may lead to thermal issues.

FIG. 6 illustrates a diagram of a conventional process in which an MCU 606 sends commands to, and reads data from, a chain of LED drivers, e.g., labeled “AMIC-1” to “AMIC-N” in FIG. 6, through a driver buffer 610. The MCU 606 can be the same as or similar to the abovementioned MCU 106A, 106B, or 406. The chain of LED drivers AMIC-1 to AMIC-N can be the same as or similar to a chain of the abovementioned LED drivers 114A, 114B, or 414-1 to 414-N. The buffer 610 can be the same as or similar to the abovementioned buffer 110.

As shown in FIG. 6, the MCU 606 sends a command 624 to the buffer 610. The buffer 610 forwards the command 624 to the LED drivers AMIC-1 to AMIC-N. The command 624, e.g., labeled “STAT AND Tj READ,” is configured to instruct the LED drivers AMIC-1 to AMIC-N to send information for the statuses of the LEDs driven by the LED drivers and information for junction temperatures of the LED drivers to the MCU 606. The LED driver AMIC-1, in response to receiving the command “STAT AND Tj READ,” generates a packet of data 626 including information for a status of LEDs driven by the LED driver AMIC-1 and information for a junction temperature in the LED driver AMIC-1. The LED driver AMIC-1 sends the command “STAT AND Tj READ” and the packet of data 626 to the next LED driver AMIC-2. The LED driver AMIC-2, in response to receiving the command “STAT AND Tj READ,” generates a packet of data 628 including information for statuses of LEDs driven by the LED drivers AMIC-1 and AMIC-2 and information for junction temperatures in the LED drivers AMIC-1 and AMIC-2. The LED driver AMIC-2 sends the command “STAT AND Tj READ” and the packet of data 628 to the next LED driver AMIC-3. Similarly, the LED driver AMIC-N, in response to receiving the command “STAT AND Tj READ,” generates a packet of data 630 including information for the statuses of LEDs driven by the LED drivers AMIC-1 to AMIC-N and information for junction temperatures in the LED drivers AMIC-1 to AMIC-N. The LED driver AMIC-N sends the packet of data 630 to the buffer 610. The buffer 610 forwards the packet of data 630 to the MCU 606. Consequently, after the MCU 606 sends the command “STAT AND Tj READ” to the buffer 610, the MCU 606 needs to wait a relatively long time to receive a response, e.g., including the packet of data 630, from the buffer 610. This extended waiting period may reduce the operational efficiency of the MCU 606.

Accordingly, solutions that address the issues discussed with respect to FIG. 1A to FIG. 6 would be beneficial.

### SUMMARY

Embodiments of the present invention provide solutions to the problems described above.

In an embodiment, an LED driving system includes a chain of LED drivers, a controller, and bridge circuitry. Each LED driver drives a set of LEDs and communicates with the other LED drivers in the chain of LED drivers through a first communication protocol. The controller controls the LED drivers to drive multiple sets of LEDs. The controller supports a second communication protocol. The bridge circuitry receives status information, indicative of a status of the multiple sets of LEDs, from the chain of LED drivers, and generates a feedback signal to control power provided to the multiple sets of LEDs based on the status information. The bridge circuitry includes a first communication interface coupled to the chain of LED drivers and configured to support the first communication protocol, and includes a second communication interface coupled to the controller and configured to support the second communication protocol. The bridge circuitry enables communication between the LED drivers and the controller through the first and second communication interfaces.

In another embodiment, an LED driving system includes a device and a chain of LED drivers. The device controls multiple power converters that include a first power converter and a second power converter. The first power converter provides first power to a first group of LED strings. The second power converter provides second power to a second group of LED strings. Each LED driver in the chain of LED drivers is configured to drive a first LED string of the first group of LED strings and a second LED string of the second group of LED strings, and send first information for a status of the first LED string and second information for a status of the second LED string to the device via a communication link that includes the chain of LED drivers. The device controls the first power based on the first information and controls the second power based on the second information.

In yet another embodiment, an LED driving system includes a chain of LED drivers and a device. Each LED driver in the chain of LED drivers is configured to drive a respective set of LEDs. The chain of LED drivers includes a first LED driver, a second LED driver, and a third LED driver. The second LED driver receives a command and a first packet of data from the first LED driver. The second LED driver, in response to receiving the command, generates a second packet of data based on the first packet of data and a status of the second LED driver. The second LED driver also sends the command and the second packet of data to the third LED driver. An LED driver that is at an end of the chain of LED drivers, in response to receiving the command, generates a combined packet of data based on a respective status of each LED driver. In a first time period, the device stores a previous packet of data received from the chain of LED drivers. In a second time period following the first time period, the device receives the command from a controller. In response to receiving the command, the device sends the previous packet of data to the controller. In the second time period, the device also forwards the command to the chain of LED drivers, receives the combined packet of data from the chain of LED drivers, and stores the combined packet of data.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1A illustrates a block diagram of a conventional LED driving system.

FIG. 1B illustrates a block diagram of a conventional LED driving system.

FIG. 2 illustrates a block diagram of a chain of LED drivers in a conventional LED driving system.

FIG. 3 illustrates a block diagram of a portion of a conventional LED driving system.

FIG. 4 illustrates a block diagram of a conventional LED driving system.

FIG. 5 illustrates a circuit diagram of a portion of a conventional LED driving system.

FIG. 6 illustrates a diagram of a conventional process in which an MCU sends commands to, and reads data from, a chain of LED drivers.

FIG. 7A illustrates a block diagram of an example of an LED driving system, in an embodiment of the present invention.

FIG. 7B illustrates a block diagram of an example of an LED driving system, in an embodiment of the present invention.

FIG. 7C illustrates a block diagram of an example of an LED driving system, in an embodiment of the present invention.

FIG. 7D illustrates a block diagram of an example of an LED driving system, in an embodiment of the present invention.

FIG. 8A illustrates a diagram showing a subset of pins/terminals of an example of a bridge circuit, in an embodiment of the present invention.

FIG. 8B illustrates a diagram showing a subset of pins/terminals of an example of a bridge circuit, in an embodiment of the present invention.

FIG. 9A illustrates a circuit diagram of a portion of an example of a bridge circuit, in an embodiment of the present invention.

FIG. 9B illustrates a circuit diagram of a portion of an example of a bridge circuit, in an embodiment of the present invention.

FIG. 10 illustrates a flowchart of an example of a method for driving multiple sets of LEDs, in an embodiment of the present invention.

FIG. 11 illustrates a block diagram of an example of an LED driving system, in an embodiment of the present invention.

FIG. 12 illustrates a circuit diagram of a portion of an example of an LED driving system, in an embodiment of the present invention.

FIG. 13 illustrates a flowchart of an example of a method for powering multiple sets of LED strings, in an embodiment of the present invention.

FIG. 14 illustrates a block diagram of an example of an LED driving system, in an embodiment of the present invention.

FIG. 15 illustrates a diagram of a process in which a controller sends commands to, and reads data from, a chain of LED drivers, in an embodiment of the present invention.

FIG. 16 illustrates a flowchart of an example of a method for sending data from a chain of LED drivers to a controller, in an embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications, and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

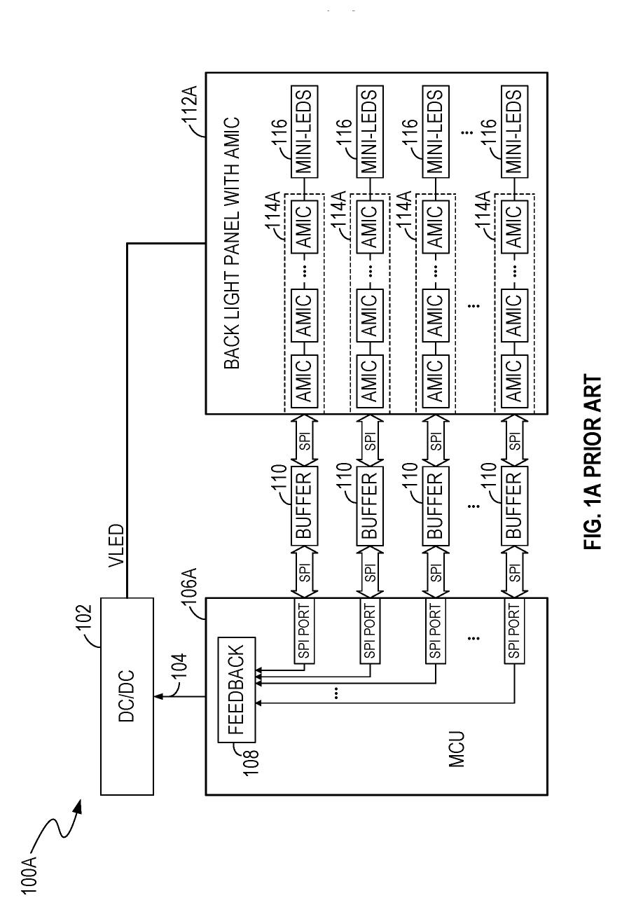

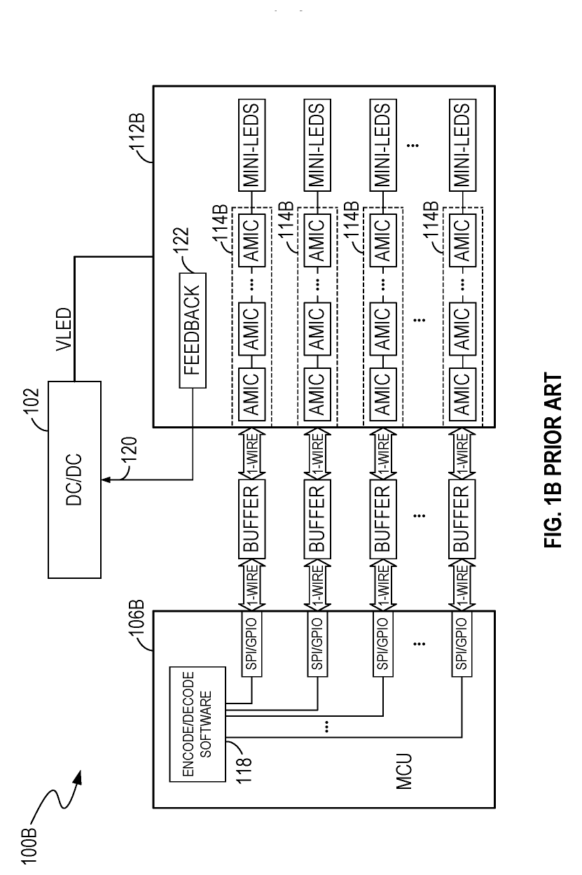

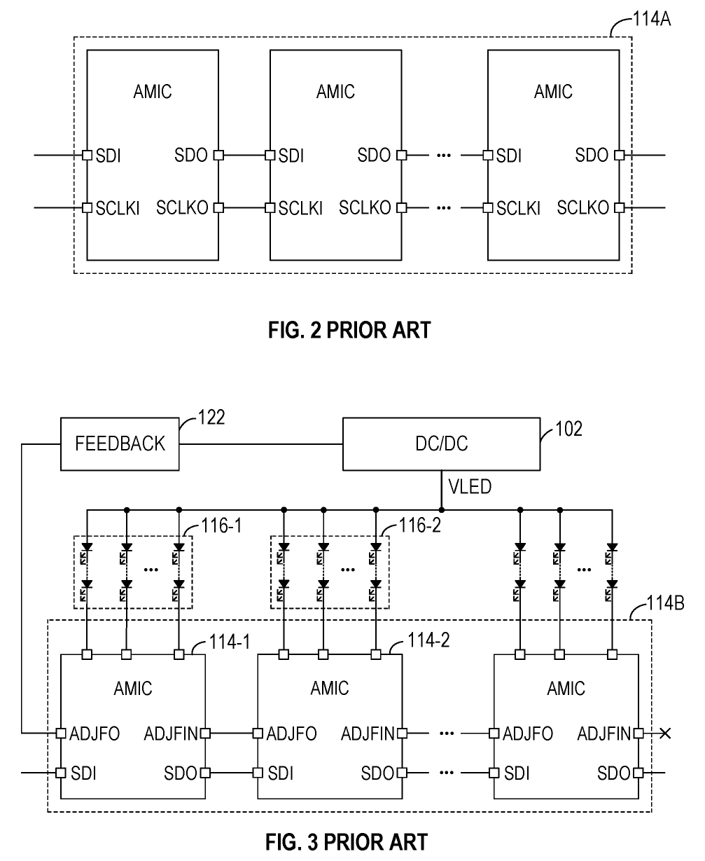

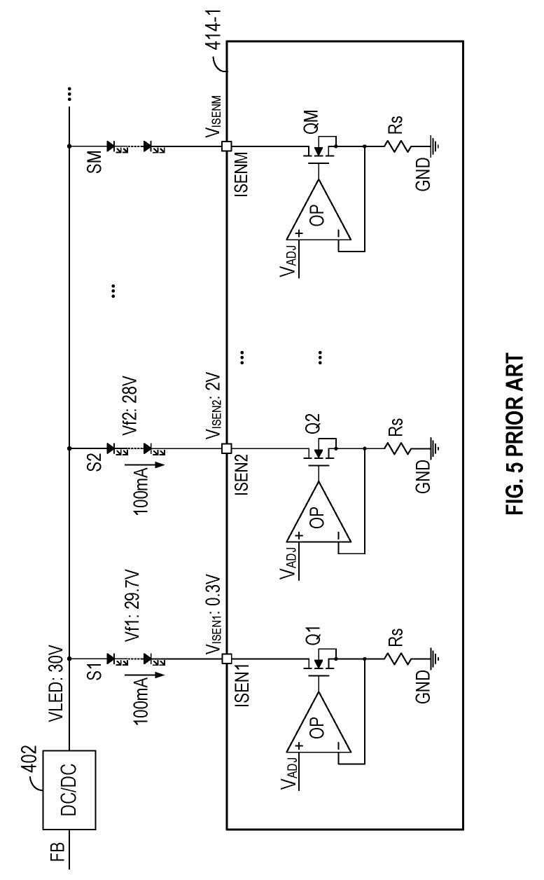

Embodiments according to the present invention provide LED driving systems. The LED driving systems include multiple LED drivers configured to drive multiple sets of LEDs, a controller configured to instruct and control the LED drivers, and bridge circuity configured to enable communication between the controller and the LED drivers and control supply power provided to the LEDs. In some embodiments according to the present invention, by using the bridge circuity, the issues discussed with respect to FIG. 1A to FIG. 6 can be solved.

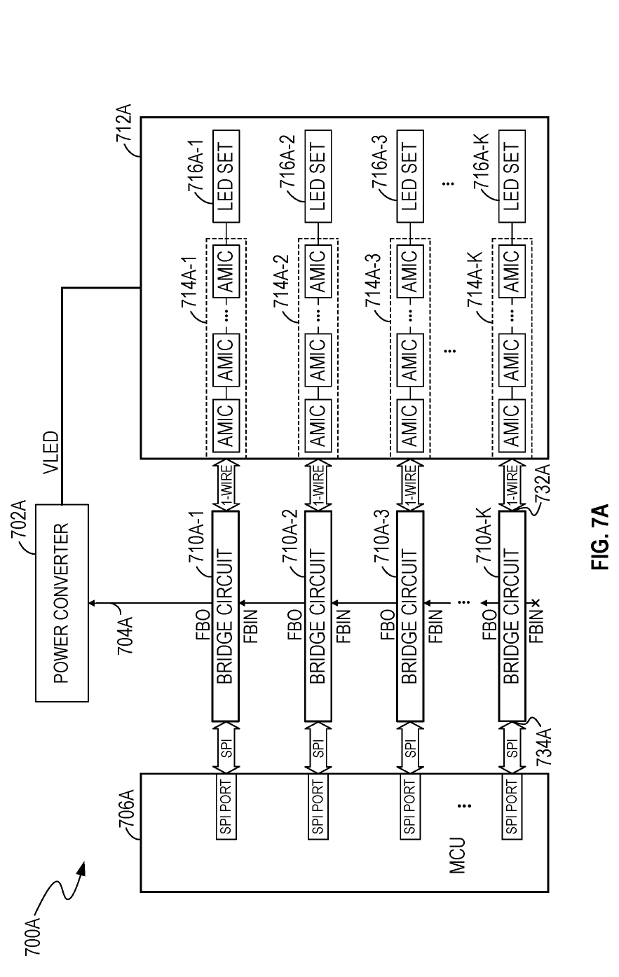

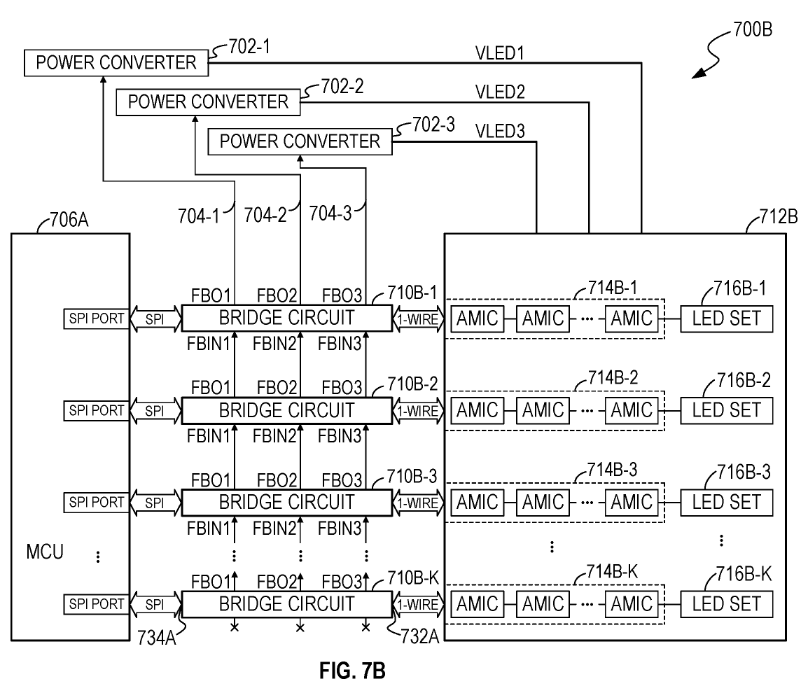

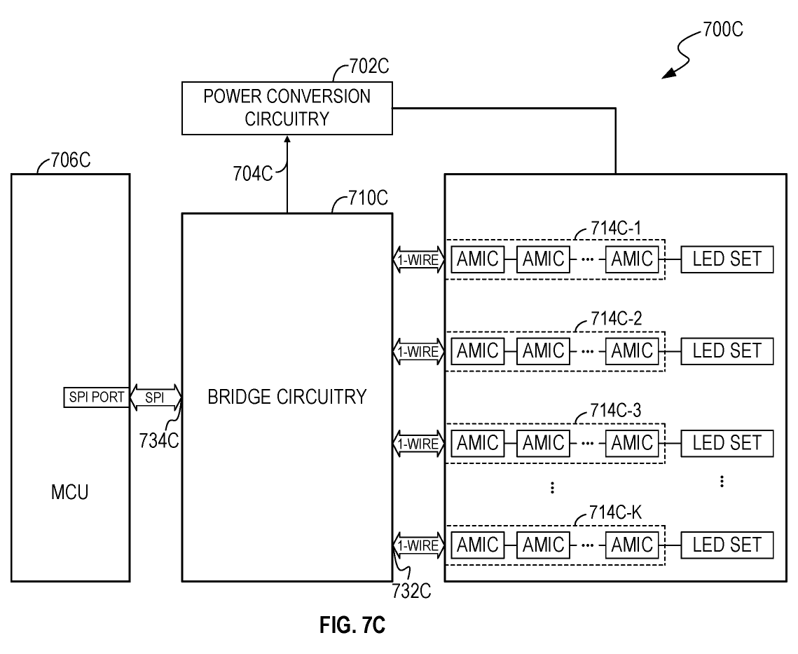

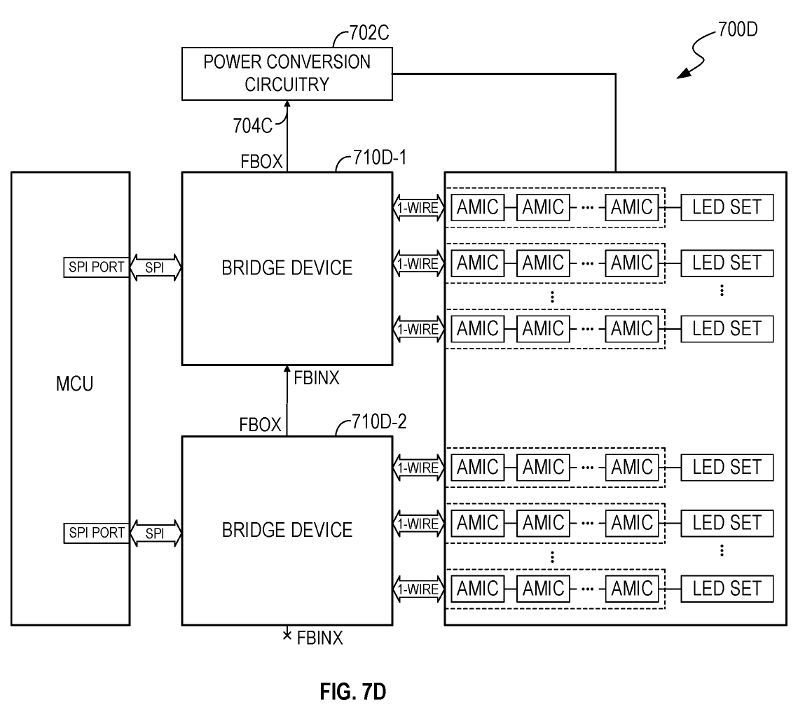

FIG. 7A illustrates a block diagram of an example of an LED driving system 700A operable for driving multiple sets of LEDs 716A-1 to 716A-K (where K is a natural number), in an embodiment of the present invention. The multiple sets of LEDs 716A-1 to 716A-K can be used in different ways including, but not limited to, in a backlight panel 712A. The multiple sets of LEDs 716A-1 to 716A-K can be referred to as LED sets 716A-1 to 716A-K. As shown in FIG. 7A, the LED driving system 700A includes multiple LED-driver chains 714A-1 to 714A-K, a controller 706A, and bridge circuity. The bridge circuitry includes a chain of bridge circuits 710A-1 to 710A-K coupled between the LED-driver chains 714A-1 to 714A-K and the controller 706A. In some embodiments, the backlight panel 712A is used in an active-matrix display panel. In these embodiments, the LEDs 716A-1 to 716A-K include “mini-LEDs,” and each LED driver in the backlight panel 712A can be referred to as an active-matrix integrated circuit (AMIC).

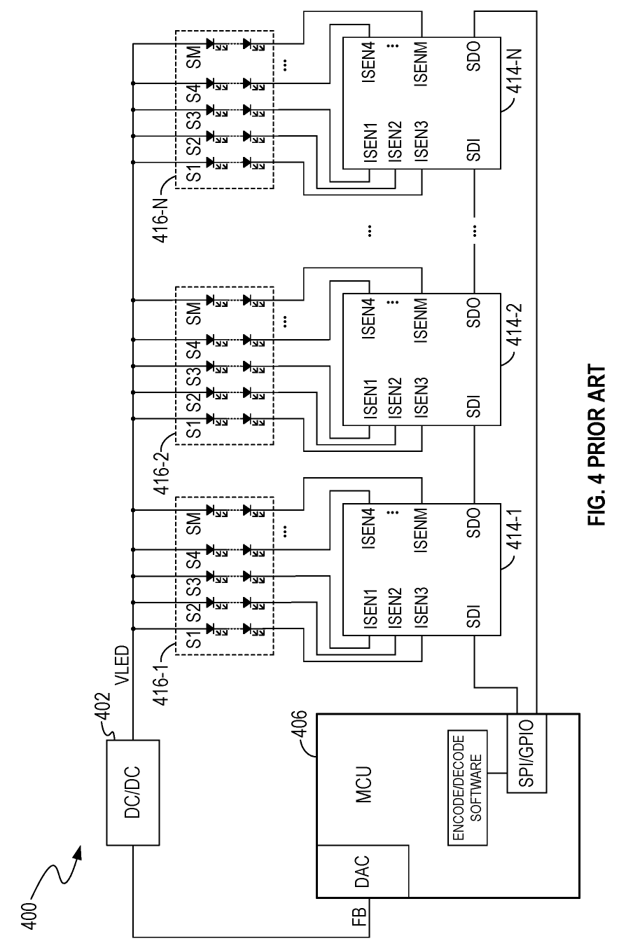

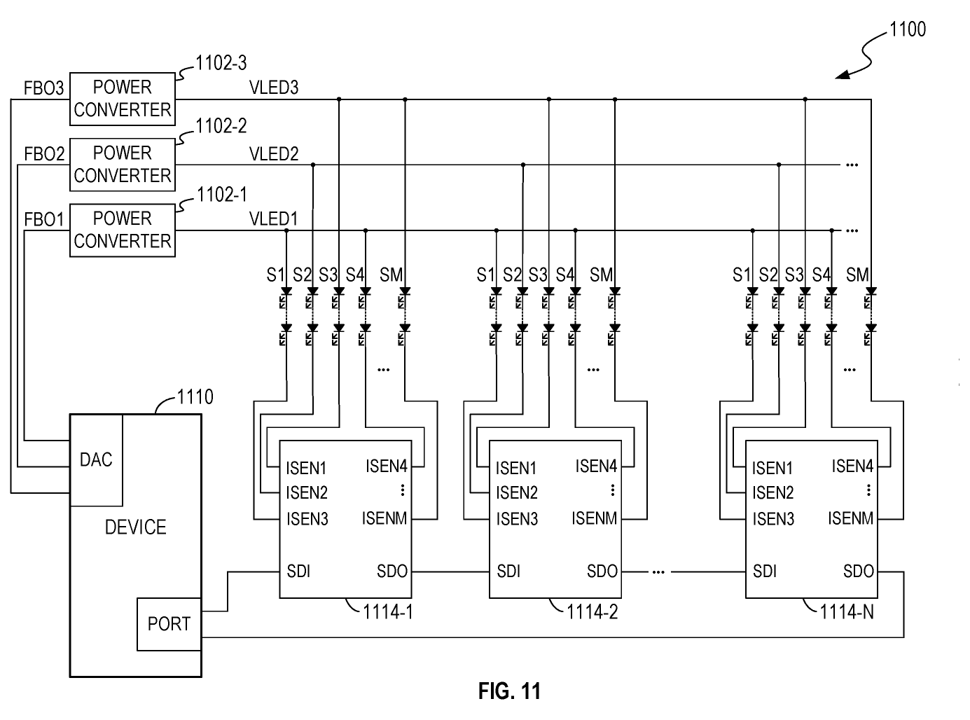

The LED-driver chains 714A-1 to 714A-K can drive the LED sets 716A-1 to 716A-K respectively. More specifically, each LED set 716A-1, 716A-2, …, or 716A-K includes multiple subsets of LEDs. Each LED-driver chain 714A-1, 714A-2, …, or 714A-K includes a chain of LED drivers (or multiple LED drivers connected in sequence). Each LED driver in the chain of LED drivers can drive a respective subset of LEDs in a corresponding LED set. For example, the LED-driver chain 714A-1 can drive the LED set 716A-1. The LED set 716A-1 can include multiple subsets of LEDs, e.g., the same as or similar to the multiple subsets of LEDs S1 to SM shown in FIG. 4 or in FIG. 11. Each LED driver in the LED-driver chain 714A-1 can drive a respective subset of LEDs.

The bridge circuits 710A-1 to 710A-K can enable communication between the controller 706A and the LED-driver chains 714A-1 to 714A-K so that the controller 706A can send commands and parameters to, and read feedback data from, the LED-driver chains 714A-1 to 714A-K. The controller 706A can control the LED-driver chains 714A-1 to 714A-K to drive the LED sets 716A-1 to 716A-K. The bridge circuits 710A-1 to 710A-K can also control a power converter 702A (or multiple power converters) to power the LED sets 716A-1 to 716A-K using a feedback signal 704A (or multiple feedback signals). In an embodiment, the power converter 702A includes a DC/DC (direct current to direct current) converter. In another embodiment, the power converter 702A may include an AC/DC (alternating current to direct current) converter.

More specifically, each LED driver in an LED-driver chain 714A-1, 714A-2, …, or 714A-K communicates with the other LED drivers in the LED-driver chain through a first communication protocol such as the 1-Wire protocol. The controller 706A supports a second communication protocol such as the SPI (serial peripheral interface) protocol. Each bridge circuit 710A-1, 710A-2, …, or 710A-K includes a first communication interface (collectively labeled as “732A”) coupled to a respective LED-driver chain 714A-1, 714A-2, …, or 714A-K and configured to support the first communication protocol, and includes a second communication interface (collectively labeled as “734A”) coupled to the controller 706A and configured to support the second communication protocol. Each bridge circuit 710A-1, 710A-2, …, or 710A-K can enable communication between the respective LED-driver chain 714A-1, 714A-2, …, or 714A-K and the controller 706A through its first communication interface 732A and second communication interface 734A. The SPI protocol can include the standard SPI Protocol, the Dual SPI protocol, the Quad SPI protocol, the Octal SPI protocol, etc.

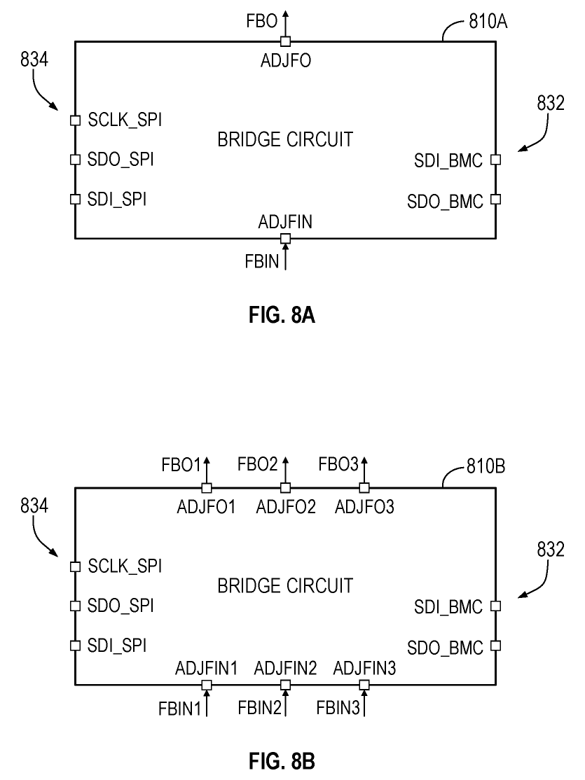

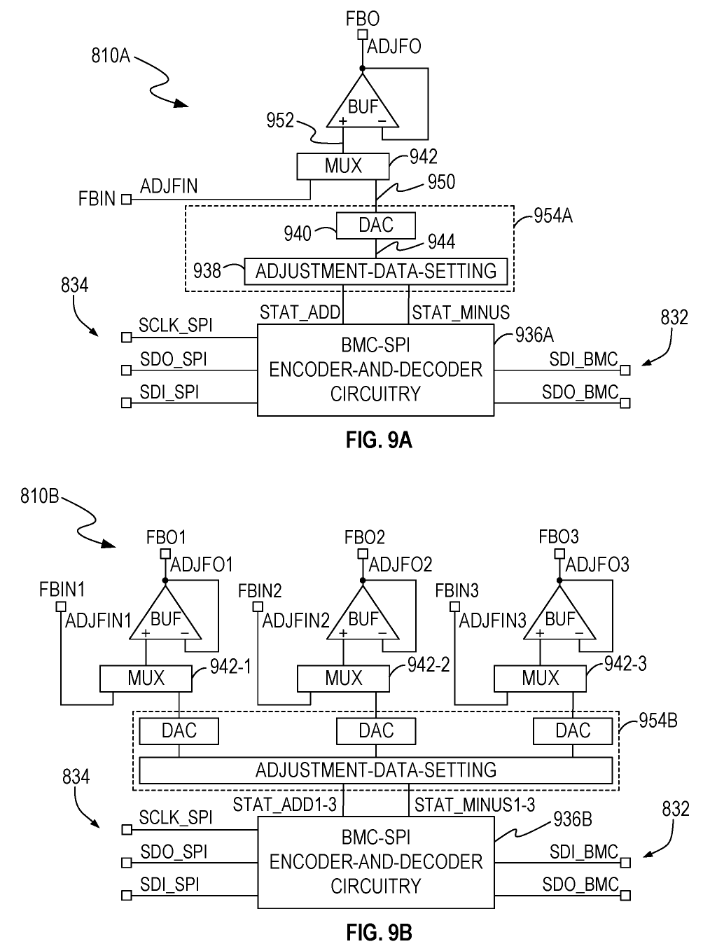

Additionally, the chain of bridge circuits 710A-1 to 710A-K can receive status information, indicative of statuses of the LED sets 716A-1 to 716A-K, from the LED-driver chains 714A-1 to 714A-K, and generate a feedback signal 704A to control the power (e.g., including a supply voltage VLED) provided to the LED sets 716A-1 to 716A-K based on the status information. In some embodiments, a status of an LED set includes whether the LED set receives sufficient power. The status of the LED set may be represented by one or more voltages at one or more sense terminals of LED drivers that drive the LED set. The following explanations are provided with reference to FIG. 7A, FIG. 8A and FIG. 9A.

FIG. 8A illustrates a diagram showing a subset of pins/terminals of an example of a bridge circuit 810A, in an embodiment of the present invention. FIG. 8A is described in combination with FIG. 7A. The bridge circuit 810A can be an embodiment of the bridge circuit 710A-1, 710A-2, …, or 710A-K. As shown in FIG. 8A, the bridge circuit 810A includes a first communication interface 832 having a signal-input pin/terminal SDI_BMC and a signal-output pin/terminal SDO_BMC. The first communication interface 832 is configured to transmit and receive BMC-encoded signals. “BMC” can refer to a line coding technique known as bi-phase mark coding. Detailed explanations for this technique are available in the known art and so are not included herein. BMC-encoded signals can refer to signals converted from an SPI format to a BMC format, as well as signals originally generated in a BMC format. The bridge circuit 810A also includes a second communication interface 834 having a clock pin/terminal SCLK_SPI, a data-input pin/terminal SDI_SPI, and a data-output pin/terminal SDO_SPI. The second communication interface 834 is configured to transmit and receive SPI-format signals. Additionally, the bridge circuit 810A includes an adjustment-signal-input pin/terminal ADJFIN and an adjustment-signal-output pin/terminal ADJFO. The input pin/terminal ADJFIN of the bridge circuit 810A can receive an adjustment signal FBIN from a bridge circuit coupled to the input pin/terminal ADJFIN. The output pin/terminal ADJFO of the bridge circuit 810A can output another adjustment signal FBO to another bridge circuit, or the power converter 702A, coupled to the output pin/terminal ADJFO.

FIG. 9A illustrates a circuit diagram of a portion of an example of the bridge circuit 810A, in an embodiment of the present invention. FIG. 9 is described in combination with FIG. 7A and FIG. 8A. As shown in FIG. 9A, the bridge circuit 810A includes signal conversion circuitry 936A, an adjustment-signal-setting circuit 954A (e.g., including a data-setting circuit 938 and a DAC 940), and a selector 942 (e.g., including a multiplexer MUX).

The signal conversion circuitry 936A can convert between signals at the first communication interface 832 and signals at the second communication interface 834. That is, the signal conversion circuitry 936A can convert BMC-encoded signals into SPI-format signals, and can convert SPI-format signals into BMC-encoded signals. For example, the signal conversion circuitry 936A includes encoder-and-decoder circuitry configured to convert between BMC-encoded signals at the first communication interface 832 and SPI-format signals at the second communication interface 834. The encoder-and-decoder circuitry 936A can also extract a set of status bits STAT_ADD and STAT_MINUS from a data packet received at the first communication interface 832. The status bits STAT_ADD and STAT_MINUS can indicate whether to increase or decrease power provided to the LEDs driven by a chain of LED drivers coupled to the first communication interface 832. The data-setting circuit 938 can receive the status bits STAT_ADD and STAT_MINUS and set adjustment data 944 according to the status bits STAT_ADD and STAT_MINUS. The DAC 940 can convert the adjustment data 944 into an internal adjustment signal 950. In other words, the adjustment-signal-setting circuit 954A can set the internal adjustment signal 950 according to the status bits STAT_ADD and STAT_MINUS.

In some embodiments, each of the status bits STAT_ADD and STAT_MINUS can have a value of “0” or “1.” The status bit STAT_ADD can be used to indicate whether to increase the supply voltage of the LEDs. The status bit STAT_ MINUS can be used to indicate whether to decrease the supply voltage of the LEDs. For example, if the status bits STAT_ADD and STAT_MINUS are “1” and “0” respectively, it can indicate to increase the supply voltage. If the status bits STAT_ADD and STAT_MINUS are “0” and “1” respectively, it can indicate to decrease the supply voltage. If both the status bits STAT_ADD and STAT_MINUS are “0,” it can indicate to continue the supply voltage unchanged. In some embodiments, the status bits STAT_ADD and STAT_MINUS may not be both “1” at the same time. The status bit STAT_ADD of “1” can cause the status bit STAT_MINUS “1” to be overwritten and set to be “0.”

The selector 942 can receive the internal adjustment signal 950 from the DAC 940 and an external adjustment signal FBIN from another bridge circuit coupled to the adjustment-signal-input pin/terminal ADJFIN of the bridge circuit 810A, and select a signal from the external adjustment signal FBIN and the internal adjustment signal 950 as an output signal 952 of the selector 942. In an embodiment, the bridge circuit 810A may include a buffer or a voltage follower, e.g., labeled “BUF” in FIG. 9A, that receives the output signal 952 and generates an adjustment signal FBO, at a voltage level of the output signal 952, at the adjustment-signal-output pin/terminal ADJFO of the bridge circuit 810A.

In some embodiments, each of the bridge circuits 710A-1 to 710A-K in FIG. 7A includes the pins/terminals and the circuit structure of the bridge circuit 810A and performs functions similar to those of the bridge circuit 810A. The bridge circuit 710A-K can generate an adjustment signal FBO based on a status of the LED set 716A-K. The signal FBO that is output from the bridge circuit 710A-K can be an external adjustment signal FBIN (e.g., similar to the signal FBIN in FIG. 9A) that is input to the bridge circuit 710A-(K-1) (not explicitly shown in FIG. 7A) adjacently coupled to the bridge circuit 710A-K (herein, “adjacently coupled” in this context is used to mean that there is not an intervening bridge circuit between, for example, the bridge circuit 710A-(K-1) and the bridge circuit 710A-K, although there may or may not be other hardware of some sort between these or any two adjacently coupled bridge circuits). The bridge circuit 710A-(K-1) can generate an internal adjustment signal (e.g., similar to the signal 950 in FIG. 9A) based on a status of the LED set 716A-(K-1). The bridge circuit 710A-(K-1) can also generate an adjustment signal (e.g., similar to the signal FBO in FIG. 9A) based on the external adjustment signal and the internal adjustment signal. The adjustment signal FBO output from the bridge circuit 710A-(K-1) can indicate the statuses of the LED sets 716A-(K-1) and 716A-K. In a similar manner, the bridge circuit 710A-1 that is at an end of the chain of bridge circuits 710A-1 to 710A-K can generate an adjustment signal FBO based on its internal adjustment signal and an external adjustment signal FBIN received from the bridge circuit 710A-2. In other words, each of the bridge circuits 710A-1 to 710A-K can communicate with the other bridge circuits in the bridge circuits 710A-1 to 710A-K using an adjustment signal (e.g., an abovementioned internal adjustment signal and/or external adjustment signal) that is indicative of a status of LEDs driven by an LED-driver chain of the 714A-1 to 714A-K. As a result, the adjustment signal FBO output from the bridge circuit 710A-1 is generated based on the statuses of the LED sets 716A-1 to 716A-K. The adjustment signal FBO output from the bridge circuit 710A-1 can function as a feedback signal 704A to control the power converter 702A that powers the LED sets 716A-1 to 716A-K. The feedback signal 704A is determined according to the adjustment signals FBO output from the bridge circuits 710A-1 to 710A-K.

Accordingly, in some embodiments, the LED drivers in the LED driving system 700A use 1-Wire interfaces for communication, each of which requires two fewer pins than the SPI interface. Thus, the LED driving system 700A can occupy a smaller PCB area, reduce costs, and have a simpler PCB layout compared to the conventional LED driving system 100A in FIG. 1A. In addition, because the bridge circuits 710A-1 to 710A-K can generate a feedback signal 704A to control the power converter 702A, the feedback module 108 (e.g., a DAC) in the MCU 106A in FIG. 1A can be omitted from the controller 706A in the LED driving system 700A, which can reduce the cost of the controller 706A. Also, the pins ADJFIN and ADJFO of each of the LED drivers in the conventional LED driving system 100B can be omitted from the LED driver in the LED driving system 700A, which can also reduce the PCB size and system cost and simplify the PCB layout. Moreover, the bridge circuits 710A-1 to 710A-K can be configured to perform a buffering function, eliminating the need for additional driver buffers and thereby enhancing the cost-effectiveness of the LED driving system 700A. Furthermore, because the bridge circuits 710A-1 to 710A-K can convert between BMC-encoded signals and SPI-format signals, the encode/decode software module 118 installed in the MCU 106B in FIG. 1B can be omitted in the controller 706A, which can further reduce the cost and power consumption of controller 706A, and improve the operational efficiency thereof.

In some embodiments, the bridge circuits 710A-1 to 710A-K can be integrated into separated IC packages and can be coupled to each other through pins such as the pins ADFJIN and ADJFO shown in FIG. 8A. In some other embodiments, the bridge circuits 710A-1 to 710A-K can be integrated into an IC package, and the bridge circuits 710A-1 to 710A-K can be coupled to each other through terminals ADFJIN and ADJFO.

In the example of FIG. 7A, the power converter 702A receives a feedback signal 704A and outputs a supply voltage VLED to the backlight panel 712A. However, the invention is not so limited. In some embodiments of the present invention, multiple power converters can receive multiple feedback signals and output multiple supply voltages to power the LEDs in the backlight panel.

FIG. 7B illustrates a block diagram of an example of an LED driving system 700B, in another embodiment of the present invention. FIG. 7B is described in combination with FIG. 7A, FIG. 8A, and FIG. 9A. In the example of FIG. 7B, the backlight panel 712B can include different types of LEDs, e.g., LEDs of different colors such as red, green, and blue. The LED-driver chains 714B-1 to 714B-K can send status information of the three types of LEDs (or referred to as three groups of LEDs) to the bridge circuits 710B-1 to 710B-K so that the bridge circuits 710B-1 to 710B-K generate feedback signals 704-1, 704-2, and 704-3 to control power converters 702-1, 702-2, and 702-3, respectively. Each of the power converters 702-1, 702-2, and 702-3 can output a supply voltage VLED1, VLED2, or VLED3 at a voltage level required by a respective group of LEDs. In some embodiments, different types of LEDs may have different forward voltages when currents at the same current level flow through the LEDs respectively. Using multiple power converters (e.g., 702-1, 702-2, and 702-3) to power different types of LEDs may reduce power loss in the LED driving system 700B.

FIG. 8B illustrates a diagram showing a subset of pins/terminals of an example of a bridge circuit 810B, in an embodiment of the present invention. FIG. 8B is described in combination with FIG. 7A, FIG. 7B, and FIG. 8A. The bridge circuit 810B can be an embodiment of the bridge circuit 710B-1 to 710B-K in FIG. 7B. In some embodiments, the functionalities of the pins/terminals SDI_BMC, SDO_BMC, SCLK_SPI, SDI_SPI, and SDO_SPI of the bridge circuit 810B are the same as or similar to those of the bridge circuit 810A in FIG. 8A. In the example of FIG. 8B, the bridge circuit 810B includes multiple adjustment-signal-input pins/terminals ADJFIN1 to ADJFIN3 configured to receive multiple adjustment signals FBIN1 to FBIN3 from a bridge circuit coupled to the adjustment-signal-input pins/terminals ADJFIN1 to ADJFIN3, and includes multiple adjustment-signal-output pins/terminals ADJFO1 to ADJFO3 configured to output multiple adjustment signals FBO1 to FBO3 to another bridge circuit, or the power converters 702-1 to 702-3, coupled to the adjustment-signal-output pins/terminals ADJFO1 to ADJFO3.

FIG. 9B illustrates a circuit diagram of a portion of an example of the bridge circuit 810B, in an embodiment of the present invention. FIG. 9B is described in combination with FIG. 7A, FIG. 7B, FIG. 8A, FIG. 8B, and FIG. 9A.

In some embodiments, the signal conversion circuitry 936B in FIG. 9B is similar to the signal conversion circuitry 936A in FIG. 9A except that the signal conversion circuitry 936B can extract multiple sets of status bits STAT_ADD1-3 and STAT_MINUS1-3 from a packet of data received at the first communication interface. For example, in the multiple sets of status bits, a first set includes status bits STAT_ADD1 and STAT_ MINUS1, a second set includes status bits STAT_ADD2 and STAT_ MINUS2, and a third set includes status bits STAT_ADD3 and STAT_ MINUS3. The three sets of status bits can respectively indicate statuses of three groups of LEDs, e.g., including a group of red LEDs, a group of blue LEDs, and a group of green LEDs. The adjustment-signal-setting circuit 954B can generate three internal adjustment signals (e.g., similar to the signal 950 in FIG. 9A) and provide the signals to selectors 942-1 to 942-3. The functionality of the selectors 942-1 to 942-3 is similar to the selector 942 in FIG. 9A. Each of the selectors 942-1 to 942-3 can select a signal from its respective external adjusting signal (e.g., FBIN1, FBIN2, or FBIN3) and internal adjustment signal as an output signal. As a result, the bridge circuit 810B can generate adjustment signals FBO1 to FBO3 at the adjustment-signal-output pins/terminals ADJFO1 to ADJFO3 according to the output signals of the selectors 942-1 to 942-3.

In the abovementioned embodiments, the bridge circuity includes multiple bridge circuits connected in a daisy-chain arrangement. Each bridge circuit includes a first communication interface coupled to a respective LED-driver chain and a second communication coupled to the controller. However, the invention is not so limited. In other embodiments, the bridge circuity can include a circuit having multiple first communication interfaces coupled to multiple LED-driver chains respectively and one or more second communication interfaces coupled to the controller.

FIG. 7C illustrates a block diagram of an example of an LED driving system 700C, in another embodiment of the present invention. FIG. 7C is described in combination with FIG. 7A, FIG. 7B, FIG. 8A, FIG. 8B, FIG. 9A, and FIG. 9B. As shown in FIG. 7C, the LED driving system 700C includes multiple LED-driver chains 714C-1 to 714C-K, power conversion circuity 702C, a controller 706C, and bridge circuity 710C.

The LED-driver chains 714C-1 to 714C-K can be the same as or similar to the abovementioned LED-driver chains 714A-1 to 714A-K or 714B-1 to 714B-K. The power conversion circuity 702C can include one or more power converters the same as or similar to the abovementioned power converters 702A and 702-1 to 702-3. The controller 706C can be similar to the abovementioned controller 706A except that the controller 706C includes one or more SPI interfaces and the total number of the SPI interfaces can be less than K, which is the total number of the LED-driver chains 714C-1 to 714C-K. For example, the controller 706C can include one SPI interface as shown in FIG. 7C. For another example, the controller 706C can include two or more SPI interfaces.

The bridge circuity 710C, e.g., referred to as a “giant-bridge device,” can include multiple first communication interfaces (collectively labeled “732C”) respectively coupled to the LED-driver chains 714C-1 to 714C-K. The first communication interface 732C can be the same as or similar to the abovementioned first communication interface 732A. The first communication interface 732C can support the 1-Wire protocol. The bridge circuity 710C can also include a second communication interface 734C coupled to the controller 706C. The second communication interface 734C can support the SPI protocol such as the standard SPI Protocol, the Dual SPI protocol, the Quad SPI protocol, or the Octal SPI protocol. The bridge circuity 710C can enable communication between the controller 706C and the LED-driver chains 714C-1 to 714C-K by converting between signals at the first communication interfaces 732C and the second communication interface 734C. In addition, the bridge circuity 710C can receive multiple instances of status information from the first communication interfaces 732C respectively. Each instance of the status information is generated by a respective LED-driver chain of the LED-driver chains 714C-1 to 714C-K and is indicative of a status of LEDs driven by the respective LED-driver chain. For example, each instance of the status information can include status bits similar to the abovementioned status bits STAT_ADD and STAT_MINUS, or status bits STAT_ADD1-3 and STAT_MINUS1-3. The bridge circuity 710C can generate one or more feedback signals 704C, e.g., similar to the abovementioned feedback signal 704A or feedback signals 704-1 to 704-3, based on the multiple instances of status information. More specifically, based on the status information received at the first communication interfaces 732C, the bridge circuity 710C can determine whether all the LEDs driven by the LED-driver chains 714C-1 to 714C-K receive sufficient power. If not, the bridge circuity 710C can adjust the one or more feedback signals 704C to control the power conversion circuity 702C to increase the power provided to the LEDs.

In another embodiment, the bridge circuity 710C can include more than one interface that is the same as or similar to the second communication interface 734C. For example, the bridge circuity 710C may include two second communication interfaces 734C. In this example, the LED-driver chains 714C-1 to 714C-K may be divided into two parts, e.g., referred to as “first part” and “second part.” The bridge circuity 710C may enable communication between the controller 706C and the first part of the LED-driver chains 714C-1 to 714C-K through their respective first communication interfaces and one of the second communication interfaces, and enable communication between the controller 706C and the second part of the LED-driver chains 714C-1 to 714C-K through their respective first communication interfaces and the other one of the second communication interfaces. Similarly, the LED-driver chains 714C-1 to 714C-K may be divided into more than two parts, with a respective communication interface for each part.

FIG. 7D illustrates a block diagram of an example of an LED driving system 700D, in another embodiment of the present invention. FIG. 7D is described in combination with FIG. 7C. The LED driving system 700D can include multiple bridge devices. In the example of FIG. 7D, the LED driving system 700D includes two bridge devices 710D-1 and 710D-2. In another example, the LED driving system 700D can include three or more bridge devices. In an embodiment, each of the bridge devices 710D-1 and 710D-2 includes circuitry the same as or similar to the bridge circuitry 710C in FIG. 7C. In addition, the bridge devices 710D-1 and 710D-2 can communicate with each other in a manner similar to the abovementioned bridge circuits 710A-1 to 710A-K or 710B-1 to 710B-K. Thus, the bridge device 710D-1 can generate one or more feedback signals 704C to control the power conversion circuitry 702C so that all the LEDs driven by the LED-driver chains receive sufficient power.

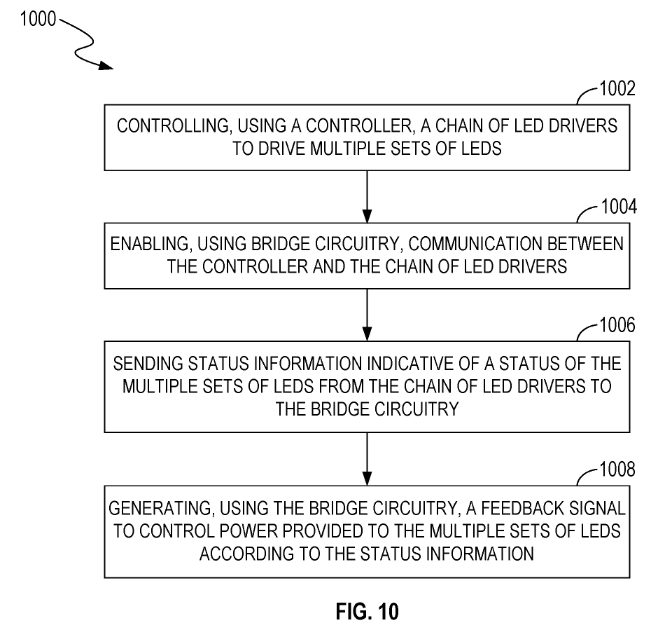

FIG. 10 illustrates a flowchart 1000 of an example of a method for driving multiple sets of LEDs, in an embodiment of the present invention. FIG. 10 is described in combination with FIG. 7A, FIG. 7B, FIG. 8A, FIG. 8B, FIG. 9A, and FIG. 9B.

At step 1002, a controller, e.g., 706A or 706C, controls a chain of LED drivers, e.g., 714A-1, 714B-1, 714C-1, etc., to drive multiple sets of LEDs, e.g., 716A-1, 716B-1, etc. Each LED driver in the chain of LED drivers is configured to drive a set of LEDs in the multiple sets of LEDs and communicate with the other LED drivers in the chain of LED drivers through a first communication protocol such as the 1-Wire protocol. The controller supports a second communication protocol such as the SPI protocol.

At step 1004, bridge circuitry, e.g., including the circuits 710A-1 to 710A-K, the circuits710B-1 to 710B-K, the circuitry 710C, or the circuitry 710D-1 and 710D-2, enables communication between the controller and the chain of LED drivers. The bridge circuity includes a first communication interface, e.g., 732A or 732C, coupled to the chain of LED drivers and configured to support the first communication protocol, and includes a second communication interface, e.g., 734A or 734C, coupled to the controller and configured to support the second communication protocol.

At step 1006, the chain of LED drivers send status information indicative of a status of the multiple sets of LEDs to the bridge circuity.

At step 1008, the bridge circuity generates a feedback signal, e.g., 704A, 704-1, 704-2, 704-3, or 704C, to control power, e.g., VLED, VLED1, VLED2, or VLED3, provided to the multiple sets of LEDs based on the status information.

FIG. 11 illustrates a block diagram of an example of an LED driving system 1100, in an embodiment of the present invention. FIG. 11 is described in combination with FIG. 7B, FIG. 7C, FIG. 7D, FIG. 8B, and FIG. 9B. As shown in FIG. 11, the LED driving system 1100 includes a device 1110, and a chain of LED drivers 1114-1 to 1114-N (where N is a natural number). In some embodiments, the device 1110 includes a bridge circuit, e.g., 710B-1 in FIG. 7B, 810B in FIG. 8B, 710C in FIG. 7C, or 710D-1 in FIG. 7D. In some other embodiments, the device 1110 may include a controller such as an MCU. In some embodiments, the chain of LED drivers 1114-1 to 1114-N can be the same as or similar to the LED-driver chain 714B-1, 714B-2, …, or 714B-K in FIG. 7B, or the LED-driver chain 714C-1, 714C-2, …, or 714C-K in FIG. 7C.

The device 1110 can control multiple power converters, e.g., including DC/DC converters or AC/DC converters. In the example of FIG. 11, the multiple power converters include a first power converter 1102-1, a second power converter 1102-2, and a third power converter 1102-3. The first power converter 1102-1 can provide first power, e.g., including a supply voltage VLED1, to a first group of LED strings, e.g., including the LED strings S1 and S4 shown in FIG. 11. The second power converter 1102-2 can provide second power, e.g., including a supply voltage VLED2, to a second group of LED strings, e.g., including the LED strings S2 shown in FIG. 11. The third power converter 1102-3 can provide third power, e.g., including a supply voltage VLED3, to a third group of LED strings, e.g., including the LED strings S3 and SM shown in FIG. 11. In some embodiments, an LED string includes one or more LEDs.

As shown in FIG. 11, each of the LED drivers 1114-1 to 1114-N is configured to drive a respective set of LED strings S1 to SM (where M is a natural number). Each set of LED strings S1 to SM includes one or more LED strings of the first group of LED strings powered by the first power converter 1102-1, one or more LED strings of the second group of LED strings powered by the second power converter 1102-2, and one or more LED strings of the third group of LED strings powered by the third power converter 1102-3. Each of the LED drivers 1114-1 to 1114-N can also sense statuses of its respective set of LED strings S1 to SM and generate first information for the status of the LED strings powered by the first power converter 1102-1, second information for the status of the LED strings powered by the second power converter 1102-2, and third information for the status of the LED strings powered by the third power converter 1102-3. Each of the LED drivers 1114-1 to 1114-N can also send the first, second, and third information to the device 1110 via a communication link that includes the LED drivers 1114-1 to 1114-N.

More specifically, in some embodiments, the LED drivers 1114-1 to 1114-N are connected in a daisy-chain arrangement and form a communication link. The LED drivers 1114-1 to 1114-N can send information to the device 1110 via the communication link. For example, if the first information generated by the LED driver 1114-1 indicates that the LED strings driven by the LED driver 1114-1 and powered by the first power converter 1102-1 require more power, then the first information of the LED driver 1114-1 can be relayed to the device 1110 through the LED drivers 1114-2, 1114-3, …, and 1114-N. Similarly, if the first information generated by the LED driver 1114-2 indicates that the LED strings driven by the LED driver 1114-2 and powered by the first power converter 1102-1 require more power, then the first information of the LED driver 1114-2 can be relayed to the device 1110 through the LED drivers 1114-3, 1114-4, …, and 1114-N.

In some embodiments, if the first information of the LED drivers 1114-1 to 1114-N indicates that all the LED strings powered by the power converter 1102-1 receive sufficient power, then the device 1110 may control the power converter 1102-1 to either keep the supply voltage VLED1 unchanged or reduce the supply voltage VLED1. If the first information of one or more of the LED drivers 1114-1 to 1114-N indicates that one or more of the LED strings powered by the power converter 1102-1 require more power, then the device 1110 controls the power converter 1102-1 to increase the supply voltage VLED1. The device 1110 can control the supply voltages VLED2 and VLED3 based on the second and third information in a similar manner.

In some embodiments, each LED string of the first, second, and third groups of LED strings includes the same number of LEDs. Additionally, in some embodiments, the first, second, and third groups of LED strings include different types of LEDs. For example, the first group of LED strings can include red-emitting LEDs, the second group can include green-emitting LEDs, and the third group can include blue-emitting LEDs. Thus, when the first, second, and third groups of LED strings are driven with the same current level, their respective forward voltages may differ. Advantageously, by controlling the power converters 1102-1 to 1102-3 to power the three groups of LED strings based on their respective statuses, power efficiency of the LED driving system 1100 can be improved, and thermal issues can be avoided in the LED drivers 1114-1 to 1114-N.

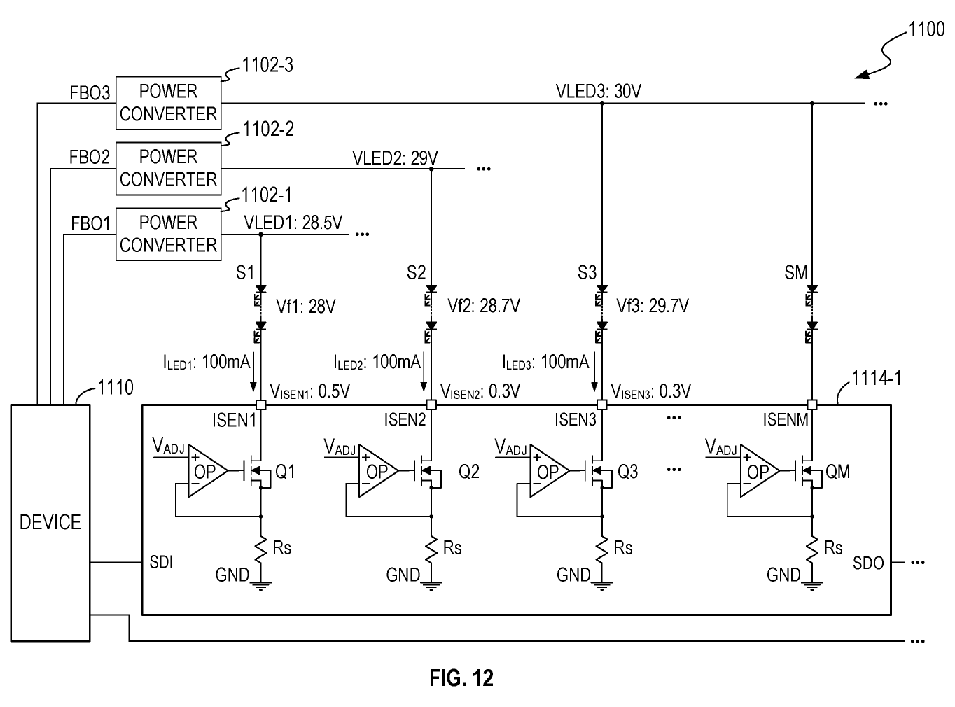

For example, FIG. 12 illustrates a circuit diagram of a portion of an example of the LED driving system 1100, in an embodiment of the present invention. FIG. 12 is described in combination with FIG. 11. As shown in FIG. 12, the LED driver 1114-1 can drive the LED string S1 by turning on an internal transistor Q1 to sink a current I_{LED1} through the LED string S1, drive the LED string S2 by turning on an internal transistor Q2 to sink a current I_{LED}₂ through the LED string S2, and drive the LED string S3 by turning on an internal transistor Q3 to sink a current I_{LED}₃ through the LED string S3. In the example of FIG. 12, currents flowing through the LED strings S1, S2, and S3 are controlled to be substantially the same, e.g., 100mA, while the forward voltages Vf1, Vf2, and Vf3 of the LED strings S1, S2, and S3 differ from each other. For example, the forward voltages of the LED strings S1, S2, and S3 may be 28V, 28.7V, and 29.7V, respectively, and the device 1110 can control the supply voltages VLED1, VLED2, and VLED3 to be 28.5V, 29V, and 30V, respectively. Thus, in this example, the voltages V_{ISEN1}, V_{ISEN2}, and V_{ISEN3} applied to, e.g., the drain terminals of, the internal transistors Q1, Q2, and Q3 can be 0.5V, 0.3V, and 0.3V, respectively. In other words, the device 1110 can control the output power of the power converters 1102-1 to 1102-3 so that voltages applied to, e.g., the drain terminals of, the internal transistors of the LED driver 1114-1 are equal to or slightly greater than a reference voltage VREF, e.g., 0.3V in the example of FIG. 12. When the voltage (e.g., V_{ISEN1}, V_{ISEN2}, or V_{ISEN3}) applied to the drain terminal on the internal transistor (e.g., Q1, Q2, or Q3) is equal to or greater than the reference voltage VREF, it can indicate that the LED string coupled to that internal transistor receives sufficient power. As a result, the device 1110 can control all the LED strings driven by the LED driver 1114-1 to receive sufficient power while minimizing power losses in the internal transistors of the LED driver 1114-1.

Accordingly, in some embodiments, if a first current (e.g., I_{LED1}) through a first LED string (e.g., S1) of the LED strings S1 to SM and a second current (e.g., I_{LED2}) through a second LED string (e.g., S2) of the LED strings S1 to SM are controlled to be at substantially the same current level, and a first forward voltage (e.g., Vf1) of the first LED string (e.g., S1) is greater than a second forward voltage (e.g., Vf2) of the second LED string (e.g., S2), then the device 1110 can control the first power (e.g., the supply voltage VLED1) provided to the first LED string (e.g., S1) to be greater than the second power (e.g., the supply voltage VLED2) provided to the second LED string (e.g., S2). As used herein, currents “are controlled to be at substantially the same current level” means that a difference may exist between the levels of the currents due to non-ideality of circuit components and the difference is relatively small and can be ignored.

In some embodiments, similar to the abovementioned bridge circuit, e.g., 710B-1, 810B, 710C, or 710D-1, the device 1110 can include a first communication interface coupled to the chain of LED drivers 1114-1 to 1114-N and configured to support a first communication protocol such as the 1-Wire protocol. The device 1110 can also include a second communication interface coupled to a controller (e.g., the same as or similar to the controller 706A or 706C) and configured to support a second communication protocol such as the SPI protocol. The device 1110 can enable communication between the controller and the chain of LED drivers 1114-1 to 1114-N through the first and second communication interfaces.

Additionally, in some embodiments, the device 1110 includes signal conversion circuitry (not shown in FIG. 11) and an adjustment-signal-setting circuit (not shown in FIG. 11). Similarly to the signal conversion circuitry 936B in FIG. 9B, the signal conversion circuitry in the device 1110 in FIG. 11 can convert between signals at the first communication interface and signals at the second communication interface. The signal conversion circuitry in the device 1110 can receive status data from the LED driver 1114-N and extract multiple sets of status bits, e.g., similar to the status bits STAT_ADD1-3 and STAT_MINUS1-3 described in relation to FIG. 9B, from the status data. Similarly to the adjustment-signal-setting circuit 954B in FIG. 9B, the adjustment-signal-setting circuit in the device 1110 in FIG. 11 can receive the multiple sets of status bits from the signal conversion circuitry and generate multiple adjustment signals FBO1 to FBO3. Each adjustment signal FBO1, FBO2, or FBO3 is generated according to a respective set of status bits of the multiple sets of status bits and is configured to control a respective power converter 1102-1, 1102-2, or 1102-3.

For example, the multiple sets of status bits can include a first set of status bits STAT_ADD1 and STAT_ MINUS1, a second set of status bits STAT_ADD2 and STAT_ MINUS2, and a third set of status bits STAT_ADD3 and STAT_ MINUS3. The first set of status bits can indicate whether to increase or decrease power output from the power converter 1102-1, the second set of status bits can indicate whether to increase or decrease power output from the power converter 1102-2, and the third set of status bits can indicate whether to increase or decrease power output from the power converter 1102-3. The device 1110 can set the values of the adjustment signals FBO1 to FBO3 according to the first, second, third sets of status bits, respectively.

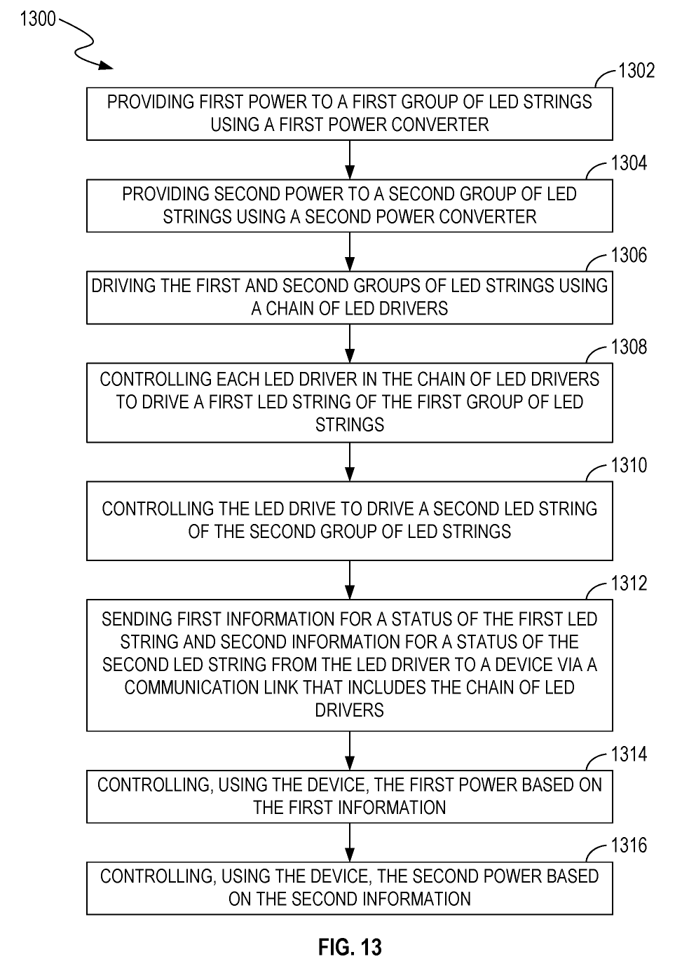

FIG. 13 illustrates a flowchart 1300 of an example of a method for powering multiple sets of LED strings, in an embodiment of the present invention. FIG. 13 is described in combination with FIG. 11 and FIG. 12.

At step 1302, a first power converter, e.g., 1102-1, provides first power, e.g., including a supply voltage VLED1, to a first group of LED strings, e.g., including the LED strings S1, S4, etc.

At step 1304, a second power converter, e.g., 1102-2, provides second power, e.g., including a supply voltage VLED2, to a second group of LED strings, e.g., including the LED strings S2, S5, etc.

At step 1306, a chain of LED drivers, e.g., 1114-1 to 1114-N, drive the first and second groups of LED strings. For example, at step 1308, each LED driver in the chain of LED drivers, e.g., 1114-1 to 1114-N, is controlled to drive a first LED string of the first group of LED strings. At step 1310, the LED drive is also controlled to drive a second LED string of the second group of LED strings.

At step 1312, the LED driver sends first information for a status of the first LED strings and second information for a status of the second LED strings to a device, e.g., 1110, via a communication link that includes the chain of LED drivers, e.g., 1114-1 to 1114-N.

At step 1314, the device 1110 controls the first power based on the first information.

At step 1316, the device 1110 controls the second power based on the second information.

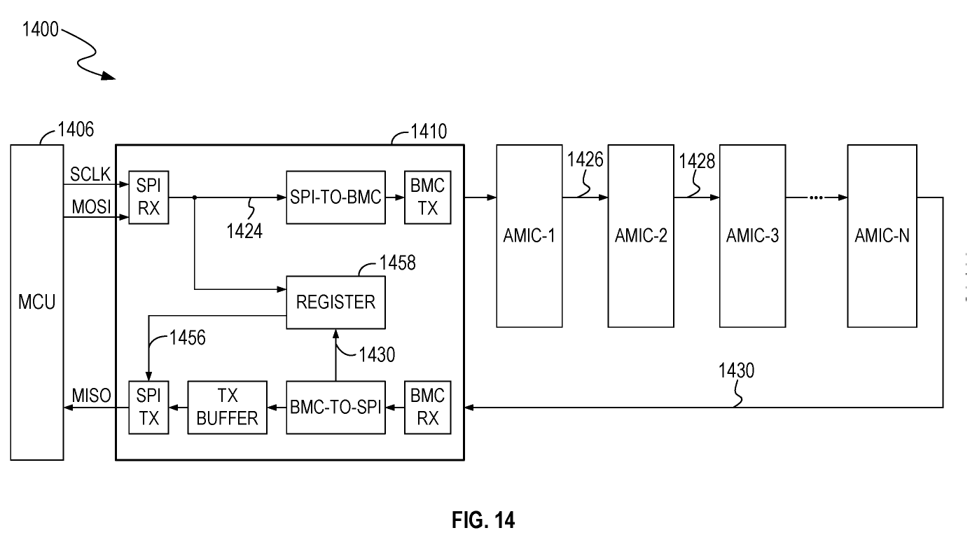

FIG. 14 illustrates a block diagram of an example of an LED driving system 1400, in an embodiment of the present invention. FIG. 14 is described in combination with FIG. 7A, FIG. 7B, FIG. 7C, FIG. 7D, FIG. 8A, FIG. 8B, FIG. 9A, FIG. 9B, and FIG. 11. As shown in FIG. 14, the LED driving system 1400 includes a controller 1406 (e.g., an MCU), a device 1410 (e.g., a bridge circuit), and a chain of LED drivers AMIC-1 to AMIC-N (where N is a natural number).

The controller 1406 can send a command 1424 to the LED drivers AMIC-1 to AMIC-N through the device 1410. The command 1424 can instruct the LED drivers AMIC-1 to AMIC-N to send their respective status information to the device 1410. The command 1424 can also cause the device 1410 to respond to the controller 1406 with status information of the LED drivers AMIC-1 to AMIC-N. In some embodiments, similar to the LED drivers 714A-1 to 714A-K in FIG. 7A, the LED drivers 714B-1 to 714B-K in FIG. 7B, and the LED drivers 1114-1 to 1114-N in FIG. 11, each LED driver of the LED drivers AMIC-1 to AMIC-N in FIG. 14 can drive a respective set of LEDs. As used herein, status information of an LED driver can include a status of the LED driver and/or a status of a set of LEDs driven by the LED driver.

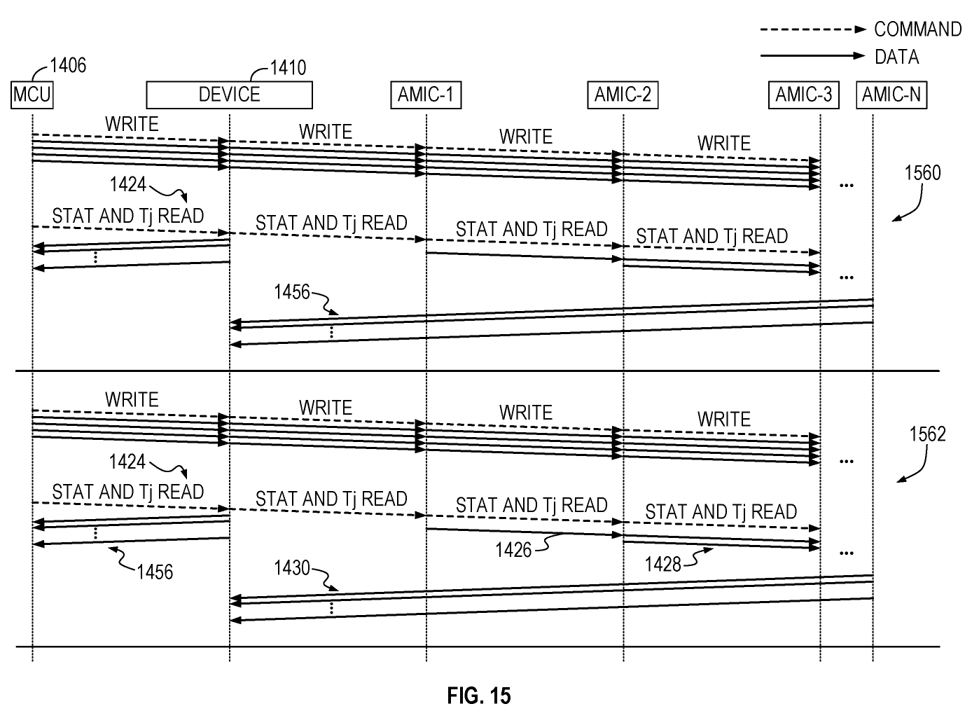

In some embodiments, the controller 1406 may send the command 1424 periodically. In a current time period, the device 1410 can receive the command 1424 and forward the command 1424 to the LED drivers AMIC-1 to AMIC-N. The LED drivers AMIC-1 to AMIC-N, in response to receiving the command 1424, can send their present status information 1430 to the device 1410. The device 1410, in response to receiving the command 1424, can send previously stored status information 1456 to the controller 1406 and wait to receive the present status information 1430 from the LED drivers AMIC-1 to AMIC-N. The previously stored status information 1456 includes the status information of the LED drivers AMIC-1 to AMIC-N that is stored in a storage unit 1458 (e.g., including a register) in a previous time period. In the current time period, the device 1410 can store the present status information 1430 received from the LED drivers AMIC-1 to AMIC-N in the storage unit 1458. The “previous time period” can be referred to as a first time period, and the “current time period” can be referred to as a second time period following the first time period. The following explanations are provided with reference to FIG. 14 and FIG. 15. FIG. 15 illustrates a diagram of a process in which the controller 1406 sends commands to, and reads data from, the chain of LED drivers AMIC-1 to AMIC-N, in an embodiment of the present invention.

As shown in FIG. 14 and FIG. 15, the LED drivers AMIC-1 to AMIC-N include a first LED driver, e.g., AMIC-1, a second LED driver, e.g., AMIC-2, and a third LED driver, e.g., AMIC-3. In the second time period 1562 (which is after the first time period 1560; e.g., either immediately after, or some time after), the device 1410 receives the command 1424 from the controller 1406 and forwards the command 1424 to the LED drivers AMIC-1 to AMIC-N. The first LED driver AMIC-1, in response to receiving the command 1424, generates a first packet of data 1426 according to a status of the LED driver AMIC-1. The second LED driver AMIC-2 receives the command 1424 and the first packet of data 1426 from the first LED driver AMIC-1. The second LED driver AMIC-2, in response to receiving the command 1424, generates a second packet of data 1428 based on the first packet of data 1426 and a status of the second LED driver AMIC-2. The second LED driver AMIC-2 also sends the command 1424 and the second packet of data 1428 to the third LED driver AMIC-3. The LED drivers AMIC-3 to AMIC-N can perform similar operations. As such, the LED driver AMIC-N that is at an end of the chain of LED drivers AMIC-1 to AMIC-N, in response to receiving the command 1424, can generate a combined packet of data 1430 based on the respective status of each of the LED drivers AMIC-1 to AMIC-N. The device 1410 receives the combined packet of data 1430 and stores it in the storage unit 1458.

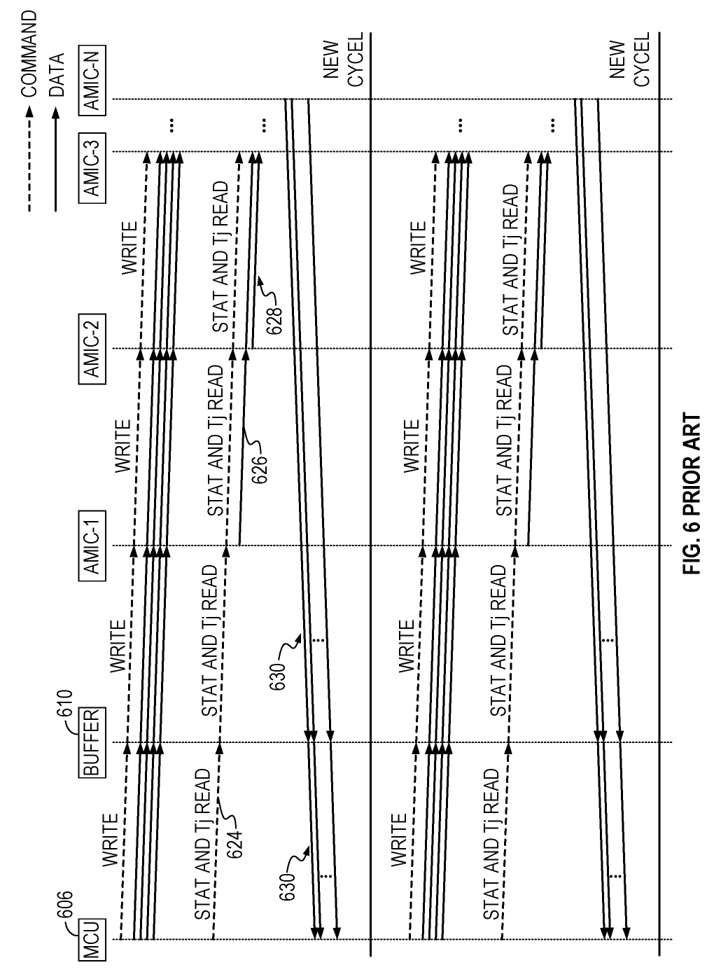

Additionally, as shown in FIG. 14 and FIG. 15, in the first time period 1560, the device 1410 and the LED drivers AMIC-1 to AMIC-N perform operations similar to those described in relation to the second time period 1562. Thus, the device 1410 can store a previous packet of data 1456 received from the LED drivers AMIC-1 to AMIC-N. In the second time period 1562, the device 1410, in response to receiving the command 1424, sends the previous packet of data 1456 to the controller 1406. Accordingly, after the controller 1406 sends a command 1424 to the device 1410, the controller 1406 does not need to wait a relatively long time to receive a response from the device 1410. The device 1410 can send a previous packet of data 1456 to the controller 1406. Thus, the operational efficiency of the controller 1406 can be improved compared to the MCU 606 mentioned in FIG. 6.

In the example of FIG. 15, the command 1424 can be labeled “STAT AND Tj READ.” “STAT” can represent status bits, and “Tj” can represent junction temperature. In some embodiments, each LED driver AMIC-1, AMIC-2, …, or AMIC-N, in response to receiving the command “STAT AND Tj READ,” can generate a packet of data based on a status of the LED driver. The status of the LED driver can include a junction temperature of the LED driver. The status of the LED driver can also include voltage levels (e.g., similar to the voltages V_{ISEN1}, V_{ISEN2}, and V_{ISEN3} shown in FIG. 12) at sense terminals (e.g., similar to the terminals ISEN1 to ISENM shown in FIG. 12) of the LED driver. Each sense terminal is configured to sense a status of an LED string driven by the LED driver. Statuses of the voltages at those sense terminals can be represented by one or more sets of status bits, e.g., similar to the status bits STAT_ADD and STAT_MINUS mentioned in relation to FIG. 9A and the status bits STAT_ADD1-3 and STAT_MINUS1-3 mentioned in relation to FIG. 9B and FIG. 11.

For example, the first LED driver AMIC-1 can drive a first set of LEDs. In a first embodiment, the first set of LEDs may be powered by one power converter (e.g., similar to the power converter 702A in FIG. 7A). In the first embodiment, the first packet of data 1426 generated by the first LED driver AMIC-1 can include information for a junction temperature Tj1 of the first LED driver AMIC-1 and a set of status bits STAT_ADD and STAT_MINUS. In a second embodiment, the first set of LEDs may include multiple subsets of LEDs powered by different power converters (e.g., similar to the power converters 1102-1 to 1102-3 in FIG. 11). In the second embodiment, the first packet of data 1426 generated by the first LED driver AMIC-1 can include information for a junction temperature Tj1 of the first LED driver AMIC-1 and multiple sets of status bits STAT_ADD1-3 and STAT_MINUS1-3.

Taking the first embodiment for example, values of the status bits STAT_ADD and STAT_MINUS, e.g., “10,” “01,” etc., in the first packet of data 1426 can indicate whether voltages at sense terminals of the first LED driver AMIC-1 are greater than a reference voltage VREF, thereby indicating whether to increase or decrease power provided to the first set of LEDs. The second LED driver AMIC-2 can drive a second set of LEDs. The first and second sets of LEDs can be powered by the same power converter. The second LED driver AMIC-2 generates the second packet of data 1428 based on the first packet of data 1426 and the status of the second LED driver AMIC-2. The second packet of data 1428 can include information for the junction temperature Tj1 of the first LED driver AMIC-1 and information for the junction temperature Tj2 of the second LED driver AMIC-2. The second packet of data 1428 can also include status bits STAT_ADD and STAT_MINUS. The status bits STAT_ADD and STAT_MINUS in the second packet of data 1428 can indicate whether to increase or decrease power provided to the first and second sets of LEDs. The LED drivers AMIC-3 to AMIC-N can generate their respective packets of data in a similar manner. As a result, the LED driver AMIC-N generates a combined packet of data that includes information for a respective junction temperature (e.g., Tj1, Tj2, Tj3, …, TjN) of each of the LED drivers AMIC-1 to AMIC-N and includes information indicating whether to increase or decrease power provided to the LEDs driven by the LED drivers AMIC-1 to AMIC-N.

In some embodiments, the device 1410 includes a bridge circuit, e.g., the bridge circuit 710A-1, …, or 710A-K in FIG. 7A, the bridge circuit 710B-1, …, or 710B-K in FIG. 7B, the bridge circuit 810A in FIG. 8A, the bridge circuit 810B in FIG. 8B, the bridge circuity 710C in FIG. 7C, the bridge circuity 710D-1 or 710D-2 in FIG. 7D. or the like. The device 1410 can include a first communication interface coupled to the chain of LED drivers AMIC-1 to AMIC-N and configured to support a first communication protocol such as the 1-Wire protocol. The device 1410 can also include a second communication interface coupled to the controller 1406 and configured to support a second communication protocol such as the SPI protocol. The device 1410 can enable communication between the controller 1406 and the chain of LED drivers AMIC-1 to AMIC-N through the first and second communication interfaces. The device 1410 can include signal conversion circuitry (e.g., including a BMC-TO-SPI module and an SPI-TO-BMC module shown in FIG. 14) configured to convert between signals (e.g., BMC-encoded signals) at the first communication interface and signals (e.g., SPI-format signals) at the second communication interface. The storage unit 1458 can receive and store status information (e.g., including the abovementioned previous packet of data 1456 and combined packet of data 1430) from the signal conversion circuitry.

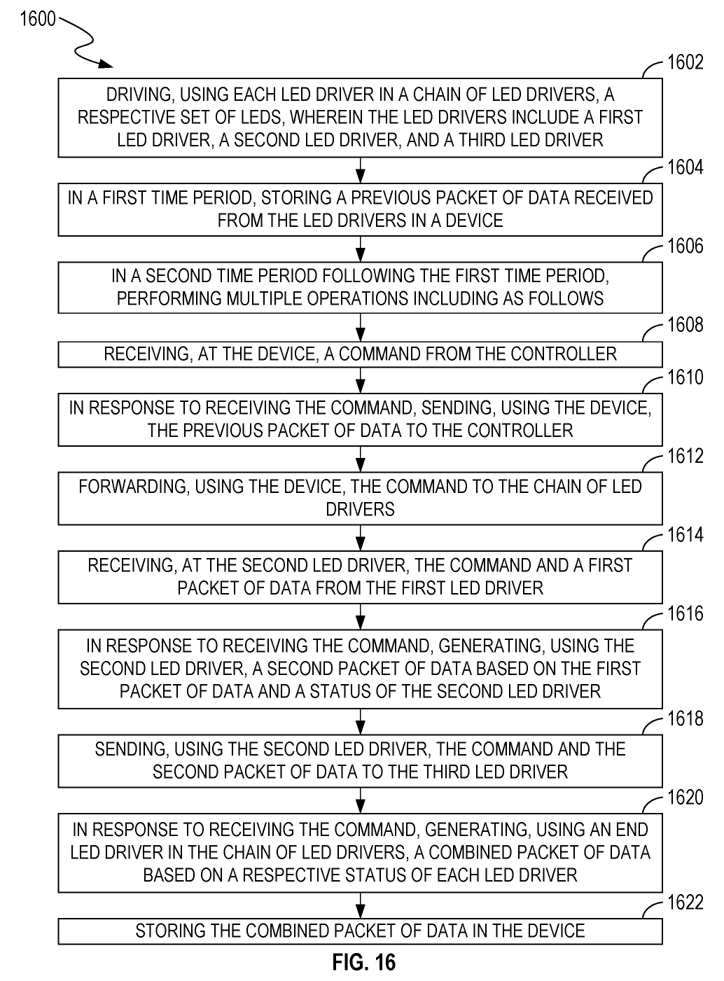

FIG. 16 illustrates a flowchart 1600 of an example of a method for sending data from a chain of LED drivers, e.g., AMIC-1 to AMIC-N, to a controller, e.g., 1406, in an embodiment of the present invention. FIG. 16 is described in combination with FIG. 14 and FIG. 15.

At step 1602, each LED driver in the chain of LED drivers AMIC-1 to AMIC-N drives a respective set of LEDs. The LED drivers AMIC-1 to AMIC-N include a first LED driver, e.g., AMIC-1, a second LED driver, e.g., AMIC-2, and a third LED driver, e.g., AMIC-3.

At step 1604, in a first time period (e.g., 1560), a device 1410 stores a previous packet of data 1456 received from the LED drivers AMIC-1 to AMIC-N.

At step 1606, in a second time period (e.g., 1562) following the first time period, the device 1410 and the LED drivers AMIC-1 to AMIC-N perform operations, e.g., including steps 1608 to 1622, as follows.

At step 1608, the device 1410 receives a command 1424 from the controller 1406.

At step 1610, the device 1410, in response to receiving the command 1424, sends the previous packet of data 1456 to the controller 1406.

At step 1612, the device 1410 forwards the command 1424 to the LED drivers AMIC-1 to AMIC-N.

At step 1614, the second LED driver AMIC-2 receives the command 1424 and a first packet of data 1426 from the first LED driver AMIC-1.

At step 1616, the second LED driver AMIC-2, in response to receiving the command 1424, generates a second packet of data 1428 based on the first packet of data 1426 and a status of the second LED driver AMIC-2.

At step 1618, the second LED driver AMIC-2 sends the command 1424 and the second packet of data 1428 to the third LED driver AMIC-3.

At step 1620, an LED driver, e.g., AMIC-N, that is at an end of the chain of LED drivers AMIC-1 to AMIC-N, in response to receiving the command 1424, generates a combined packet of data 1430 based on a respective status of each of the LED drivers AMIC-1 to AMIC-N.

At step 1622, the device 1410 stores the combined packet of data 1430 in a storage unit, e.g., 1458.

While the foregoing description and drawings represent embodiments of the present invention, it will be understood that various additions, modifications, and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An LED driving system comprising:
a first chain of LED drivers, wherein each LED driver in said first chain of LED drivers is configured to drive a set of LEDs and communicate with the other LED drivers in said first chain of LED drivers through a first communication protocol;
a controller configured to control said first chain of LED drivers to drive a first plurality of sets of LEDs, wherein said controller supports a second communication protocol; and
bridge circuitry, coupled between said first chain of LED drivers and said controller, configured to receive status information, indicative of a status of said first plurality of sets of LEDs, from said first chain of LED drivers, and configured to generate a feedback signal to control power provided to said first plurality of sets of LEDs based on said status information, wherein said bridge circuitry comprises:
a first communication interface coupled to said first chain of LED drivers and configured to support said first communication protocol, and
a second communication interface coupled to said controller and configured to support said second communication protocol, and
wherein said bridge circuitry is further configured to enable communication between said first chain of LED drivers and said controller through said first and second communication interfaces.

2. The LED driving system of claim 1, wherein said first communication protocol comprises the 1-Wire protocol and said second communication protocol comprises the SPI (serial peripheral interface) protocol.

3. The LED driving system of claim 1, wherein said bridge circuitry comprises encoder-and-decoder circuitry configured to convert between signals at said first communication interface and signals at said second communication interface.

4. The LED driving system of claim 1, wherein said LED driving system further comprises a second chain of LED drivers configured to drive a second plurality of sets of LEDs, and wherein said bridge circuitry further comprises:
a first bridge circuit, coupled to said second chain of LED drivers, and configured to generate a first adjustment signal based on a status of a second plurality of sets of LEDs driven by said second chain of LED drivers; and
a second bridge circuit, coupled to said first chain of LED drivers and adjacently coupled to said first bridge circuit, and configured to receive said first adjustment signal, generate an internal adjustment signal based on said status of said first plurality of sets of LEDs, and generate a second adjustment signal based on said first adjustment signal and said internal adjustment signal,
wherein said feedback signal is determined according to at least said first and second adjustment signals.

5. The LED driving system of claim 4, wherein said second bridge circuit comprises:
an adjustment-signal-setting circuit configured to set said internal adjustment signal based on a set of status bits received from said first communication interface, wherein said set of status bits indicates whether to increase or decrease said power provided to said first plurality of sets of LEDs.

6. The LED driving system of claim 5, wherein said second bridge circuit further comprises a selector configured to receive said internal adjustment signal and said first adjustment signal, and to select a signal from said first adjustment signal and said internal adjustment signal as an output signal of said selector, and wherein said second adjustment signal comprises a level of said output signal.

7. The LED driving system of claim 5, wherein said second bridge circuit further comprises signal conversion circuitry configured to convert between signals at said first communication interface and signals at said second communication interface, and wherein said adjustment-signal-setting circuit receives said set of status bits from said signal conversion circuitry.

8. The LED driving system of claim 1, further comprising a plurality of LED-driver chains, wherein each chain of said plurality of LED-driver chains comprises a chain of LED drivers, and wherein said plurality of LED-driver chains comprises said first chain of LED drivers;
wherein said bridge circuitry comprises a chain of bridge circuits comprising said first bridge circuit, and each bridge circuit in said chain of bridge circuits is configured to enable communication between said controller and a respective LED-driver chain in said plurality of LED-driver chains and is also configured to communicate with the other bridge circuits in said chain of bridge circuits using an adjustment signal that is indicative of a status of LEDs driven by an LED-driver chain in said plurality of LED-driver chains;
wherein said first bridge circuit is at an end of said chain of bridge circuits; and
wherein said feedback signal controls a power converter that powers LEDs driven by said plurality of LED-driver chains.

9. The LED driving system of claim 1, further comprising a plurality of LED-driver chains, wherein each chain of said plurality of LED-driver chains comprises a chain of LED drivers, and wherein said plurality of LED-driver chains comprises said first chain of LED drivers;
wherein said bridge circuitry comprises a plurality of first communication interfaces respectively coupled to said plurality of LED-driver chains;
wherein said bridge circuitry is configured to enable communication between said controller and said plurality of LED-driver chains by converting between signals at said plurality of first communication interfaces and signals at said second communication interface;
wherein said bridge circuitry is configured to receive a plurality of instances of status information from said plurality of first communication interfaces respectively, and each instance of said plurality of instances of status information is generated by a respective LED-driver chain of said plurality of LED-driver chains and is indicative of a status of LEDs driven by said respective LED-driver chain; and
wherein said bridge circuitry is further configured to generate said feedback signal based on said plurality of instances of status information.

10. An LED driving system comprising:
a device configured to control a plurality of power converters that comprise a first power converter and a second power converter, wherein said first power converter is configured to provide first power to a first group of LED strings, and wherein said second power converter is configured to provide second power to a second group of LED strings; and
a chain of LED drivers coupled to said device, wherein each LED driver in said chain of LED drivers is configured to drive a first LED string of said first group of LED strings and a second LED string of said second group of LED strings, and to send first information for a status of said first LED string and second information for a status of said second LED string to said device via a communication link that comprises said chain of LED drivers,
wherein said device is configured to control said first power based on said first information and control said second power based on said second information.

11. The LED driving system of claim 10, wherein said LED driver is configured to drive said first LED string by sinking a first current through said first LED string, and drive said second LED string by sinking a second current through said second LED string, and wherein if said first and second currents are controlled to be at substantially the same current level and a first forward voltage of said first LED string is greater than a second forward voltage of said second LED string, then said device is configured to control said first power to be greater than said second power.

12. The LED driving system of claim 10, wherein said device is further configured to receive a plurality of sets of status bits from an LED driver that is at an end of said chain of LED drivers, wherein each set of said plurality of sets of status bits indicates whether to increase or decrease output power of a respective power converter of said plurality of power converters, wherein said device is also configured to generate a plurality of adjustment signals to control said plurality of power converters respectively, and wherein each signal of said plurality of adjustment signals is generated according to a respective set of status bits of said plurality of sets of status bits.

13. The LED driving system of claim 10, wherein said device comprises:
a first communication interface coupled to said chain of LED drivers and configured to support a first communication protocol, and
a second communication interface coupled to a controller and configured to support a second communication protocol, and
wherein said device is further configured to enable communication between said controller and said chain of LED drivers through said first and second communication interfaces.

14. The LED driving system of claim 13, wherein said device further comprises:
signal conversion circuitry configured to convert between signals at said first communication interface and signals at said second communication interface; and
an adjustment-signal-setting circuit configured to receive a plurality of sets of status bits from said signal conversion circuitry and to generate a plurality of adjustment signals, wherein each signal of said plurality of adjustment signals is generated according to a respective set of status bits of said plurality of sets of status bits and is configured to control a respective power converter of said plurality of power converters.

15. An LED driving system comprising:
a chain of LED drivers, each LED driver in said chain of LED drivers configured to drive a respective set of LEDs, wherein said chain of LED drivers comprises a first LED driver, a second LED driver, and a third LED driver, wherein said second LED driver is configured to:
receive a command and a first packet of data from said first LED driver,
in response to receiving said command, generate a second packet of data based on said first packet of data and a status of said second LED driver, and
send said command and said second packet of data to said third LED driver, and
wherein an LED driver that is at an end of said chain of LED drivers is configured to, in response to receiving said command, generate a combined packet of data based on a respective status of said each LED driver; and
a device, coupled to said chain of LED drivers, configured to:
store a previous packet of data received from said chain of LED drivers in a first time period,
receive said command from a controller in a second time period following said first time period, and
in response to receiving said command, send said previous packet of data to said controller,
wherein in said second time period, said device is configured to forward said command to said chain of LED drivers, receive said combined packet of data from said chain of LED drivers, and store said combined packet of data.

16. The LED driving system of claim 15, wherein in said first time period,
said device is configured to forward a previous command from said controller to said chain of LED drivers; and
said second LED driver is configured to:
receive said previous command and a previous first packet of data from said first LED driver,
in response to receiving said previous command, generate a previous second packet of data based on said previous first packet of data and a status of said second LED driver, and
send said previous command and said previous second packet of data to said third LED driver; and
wherein said LED driver that is at said end of said chain of LED drivers is configured to, in response to receiving said previous command, generate said previous packet of data.

17. The LED driving system of claim 15, wherein said status of said second LED driver comprises at least one status of a first status and a second status, wherein said first status comprises a voltage level at a sense terminal of said second LED driver that senses a status of at least one LED driven by said second LED driver, and wherein said second status comprises a temperature of said second LED driver.

18. The LED driving system of claim 15, wherein said combined packet of data includes information for a respective junction temperature of said each LED driver in said chain of LED drivers and includes information indicating whether to increase or decrease power provided to a plurality of sets of LEDs driven by said chain of LED drivers.

19. The LED driving system of claim 15, wherein said device comprises:
a first communication interface coupled to said chain of LED drivers and configured to support a first communication protocol, and
a second communication interface coupled to said controller and configured to support a second communication protocol, and
wherein said device is configured to enable communication between said controller and said chain of LED drivers through said first and second communication interfaces.

20. The LED driving system of claim 19, wherein said device further comprises:
signal conversion circuitry configured to convert between signals at said first communication interface and signals at said second communication interface; and
a storage unit, coupled to said signal conversion circuitry, and configured to receive and store said previous packet of data from said signal conversion circuitry in said first time period.
